(19) United States
(12) Patent Application Publication
(10) Pub. No.: US 2019/0378093 A1
(43) Pub. Date: Dec. 12, 2019

(54) Measuring Degree Of Match By Importance Of Need And Credibility Of Skills

(71) Applicants: Manu Mehta, Fremont, CA (US); Anjali Dayal, Pleasanton, CA (US); Yiu Wan Lau, Pacheco, CA (US); Aradhana Mehta, Fremont, CA (US); Nitin Mehta, Fremont, CA (US); Saiba Singh, Pleasanton, CA (US); Lynn Randolph Slater, JR., Pleasanton, CA (US)

(72) Inventors: Manu Mehta, Fremont, CA (US); Anjali Dayal, Pleasanton, CA (US); Yiu Wan Lau, Pacheco, CA (US); Aradhana Mehta, Fremont, CA (US); Nitin Mehta, Fremont, CA (US); Saiba Singh, Pleasanton, CA (US); Lynn Randolph Slater, JR., Pleasanton, CA (US)

(21) Appl. No.: 16/434,184

(22) Filed: Jun. 7, 2019

Related U.S. Application Data
(60) Provisional application No. 62/682,187, filed on Jun. 8, 2018.

(51) Int. Cl. G06Q 10/10; H04L 29/08; G06F 16/9536; G06Q 10/06

(52) U.S. Cl. CPC G06Q 10/1053; G06Q 10/063112; G06F 16/9536; H04L 67/306

(57) ABSTRACT

A method and an opportunity matching system (OMS) for determining a degree of match between opportunity seeker profiles with opportunity seeker skills of varying credibility and opportunity descriptions with opportunity description skills of varying importance are provided. The OMS receives a first skill list including the opportunity seeker skills and a second skill list including the opportunity description skills from a skill list database and creates a unique skill list including unique opportunity seeker skills, a merged skill amount measure corresponding to each unique opportunity seeker skill, and a merged credibility measure indicating credibility of the merged skill amount measure by performing merging actions on first tuples in the first skill list. The OMS generates an opportunity match score by processing a skill match score generated for each opportunity description skill in a matched skill list created by matching the unique opportunity seeker skills with the opportunity description skills.

### CROSS-REFERENCE TO RELATED APPLICATIONS

This application claims priority to and the benefit of the provisional patent application titled “Measuring Degree Of Match By Importance Of Need And Credibility Of Skills”, application No. 62/682,187, filed in the United States Patent and Trademark Office on Jun. 8, 2018. The specification of the above referenced patent application is incorporated herein by reference in its entirety.

### BACKGROUND

As jobs are created or as existing jobs remain unfilled, there is a need to find candidates who may fill these jobs. As job seekers enter an employment marketplace, there is a need to find jobs that they may fill. Often the matching of a job to a job seeker is based on matching the description of a job opening to the resume of a job seeker. However, the resumes are often inaccurate. Therefore, there is a need for matching a job seeker to job descriptions using information beyond that contained in a resume created by the job seeker. The need for matching a job needs to match the requirements of the jobs and not the job seekers needs.

Accurate resumes often describe only specific job skills possessed by the job seeker without any specific description about the personal traits of the job seeker. Descriptions of a job opening typically include job skills and may include certain desired personal traits. However, an interview with the job seeker often fails to identify the personal traits of the job seeker. Dissatisfaction by an employer or in an employed person in a job with the employer, often result when the job is filled by a job seeker with the required job skills match the requirements of the job but where the personal traits of the employee do not match the job. The job may be performed inefficiently by the employed person, and the job may become vacant again and be required to be filled. Hence, there is a need for matching a job seeker to the job description with a consideration of the personal traits of the job seeker, even when the personal traits are discovered using information outside that present in a resume created by the job seeker. The need for matching a job should not be based on inaccurate text descriptions provided in the job seeker resumes, and the corresponding inappropriate matches with the job description.

An alternative source of information about job skills and personal traits of a job seeker is ratings provided by other people, for example, previous employers of the job seeker, a guidance counselor of the job seeker, etc. Like the information contained in a resume of the job seeker, the ratings provided by other people may be inaccurate, possibly due to personal bias or from a lack of knowledge about certain job skills or personal traits possessed by the job seeker. Furthermore, while using a computer system to determine whether a rating provided for the job skills and the personal traits of the job seeker is accurate is not feasible, the computer system can be programmed to assign a credibility measure to the rating and the employer can use the assigned credibility measure that defines the credibility of the rating as a factor when using the rating to match the job seeker to a job. Hence, there is a need for including ratings provided for the job skills and the personal traits of the job seeker, and the credibility of each of the ratings, along with the job skills and the personal traits declared in a resume when matching a job seeker to a job description.

The number of job seekers that may be considered for a job is generally much larger than an employer can interview and actually consider for employment. An employer would prefer to consider only the most suitable job seekers. Conversely, a job seeker would prefer to participate in an interview process only for jobs for which the job seeker is likely to be a good fit. To identify the most suitable job seeker for a job opening by the employer and the jobs for which the job seekers are suitable, there is a need for computing a single numerical score derived from the ratings of the job skills and the personal traits of the job seekers and the credibility of each of the ratings, where the computed single numerical score can be used to sort the highest scoring job seekers to present to the employer seeking to fill a job, and to sort the highest scoring jobs to present to a job seeker seeking employment. Hence, there is a need for including the ratings of the job skills and the personal traits of the job seekers and the credibility of each of the ratings, along with the job skills and the personal traits declared in a resume for a job description that results in a computation of a single numerical score. Further, the single numerical score sorts the job seekers for employers, and also sorts jobs for the job seekers.

Hence, there is a long felt but unresolved need for a method and a system for determining a degree of match between opportunity seeker profiles, for example, job seeker profiles, with opportunity seeker skills, for example, job skills and personal traits of varying credibility, and opportunity descriptions, for example, job descriptions, with opportunity description skills, for example, job description skills of varying importance by computing a single numerical opportunity match score.

### SUMMARY OF THE INVENTION

This summary is provided to introduce a selection of concepts in a simplified form that are further disclosed in the detailed description of the invention. This summary is not intended to determine the scope of the claimed subject matter.

The method and the system disclosed herein address the above recited need for determining a degree of match between opportunity seeker profiles, for example, job seeker profiles, with opportunity seeker skills, for example, job skills and core personal traits of varying credibility, and opportunity descriptions, for example, job descriptions with opportunity description skills, for example, job description skills of varying importance by computing a single numerical opportunity match score. The method and the system disclosed herein relate to how opportunity seekers, for example, job seekers, are matched to opportunities, for example, jobs in an employment process. The method disclosed herein employs an opportunity matching system comprising at least one processor configured to execute computer program instructions for determining a degree of match between the opportunity seeker profiles with the opportunity seeker skills of varying credibility and the opportunity descriptions with the opportunity description skills of varying importance. The opportunity matching system computes the single numerical opportunity match score for the degree of match between possessed skills of an opportunity seeker and needed skills for an opportunity. The opportunity matching system invokes the method disclosed herein separately for determining the degree of match between different combinations of possessed skills and needed skills, for example, by matching the possessed skills of multiple opportunity seekers against the skills needed for multiple opportunities.

The opportunity matching system receives a list of skills present in opportunity seeker profiles and a list of skills needed as stated in opportunity descriptions provided by entities, from a skill list database. The skill list database comprises predefined opportunity seeker skills and opportunity description skills that form the list of skills declared by the opportunity seeker, and the list of skills needed by the employer, respectively. The opportunity seeker skills in the list of skills present that occur multiple times with different corresponding amount present measures and different corresponding credibility measures. The list of skills present is not a unified list. The list of skills present in an opportunity seeker comprises skills classified as domains of expertise, for example, expertise in Microsoft® Word of Microsoft Corporation, hypertext preprocessor (PHP) programming language, floor sweeping, etc., and core personal traits, for example, confidence, dependability, etc., of the opportunity seekers. The opportunity seeker skills in the list of skills present have corresponding opportunity seeker skill amount measures and credibility measures indicating the credibility of the opportunity seeker skill amount measures. The list of skills needed comprise the opportunity description skills classified as domains of expertise and core personal traits of the opportunity seekers required for the opportunity. The opportunity description skills in the list of skills needed have corresponding importance measures, corresponding requirement measures, and corresponding opportunity description skill amount measures.

The opportunity matching system processes the list of skills present and generates a unique skill list, that is, a merged list of skills present in the opportunity seeker profiles. The merged list of the skills present comprises each skill in the opportunity seeker profiles occurring only once with a merged amount declared measure and a merged credibility measure. The opportunity matching system matches the merged list of skills present in the opportunity seeker to the list of skills needed by the employer. The matching results in a list of skills comprising matched entries with a merged amount present skill measure and a merged credibility measure, a “is required” (ISREQ) measure, an importance measure, and an amount needed measure. The opportunity matching system computes a skill match score for each of the matched entries in the merged list of the skills present. The opportunity matching system computes an opportunity match score defining the degree of match between the possessed skills of an opportunity seeker and the needed skills for an opportunity by combining the computed skill match scores. In an embodiment, the opportunity matching system assigns default values to the merged amount present measure and the merged credibility measure when the opportunity description skill is not already in the list of skills present.

The list of skills present in the opportunity seeker profiles is generated by operational systems of entities by an assessment of the opportunity seeker skills present, for example, from reviews of the opportunity seeker profiles and resumes of the opportunity seekers. The assessments result in identifying an opportunity seeker skill, and a corresponding amount present measure, and a corresponding measure of credibility of the amount present measure. The list of skills needed is generated by the operational systems of the entities on assessment of the opportunity description skills needed, for example, from extracts of the opportunity descriptions. The assessments of the opportunity description skills include identifying an opportunity description skill, indicating an is required (ISREQ) measure of the opportunity description skill using a flag, a measure of the importance of the opportunity description skill, and a measure of the amount of the opportunity description skill needed. In the list of skills needed, an opportunity description skill is present only once.

The opportunity match score indicates a match of one opportunity description against one opportunity seeker profile. The computation of the opportunity match score comprises the credibility of the assessments and importance of the opportunity seeker skills to the entities, for example, employers. Furthermore, the method for computing the opportunity match score considers the core personal traits of the opportunity seekers and includes default values for an opportunity seeker skill amount measure and a credibility measure for unreported core personal traits.

In one or more embodiments, related systems comprise circuitry and/or programming for effecting the methods disclosed herein; the circuitry and/or programming can be any combination of hardware, software, and/or firmware configured to effect the methods disclosed herein depending upon the design choices of a system designer. Also, in an embodiment, various structural elements can be employed depending on the design choices of the system designer.

### BRIEF DESCRIPTION OF THE DRAWINGS

The foregoing summary, as well as the following detailed description of the invention, is better understood when read in conjunction with the appended drawings. For illustrating the invention, exemplary constructions of the invention are shown in the drawings. However, the invention is not limited to the specific methods and components disclosed herein. The description of a method step or a component referenced by a numeral in a drawing is applicable to the description of that method step or component shown by that same numeral in any subsequent drawing herein.

FIG. 1 illustrates a method for determining a degree of match between opportunity seeker profiles with opportunity seeker skills of varying credibility and opportunity descriptions with opportunity description skills of varying importance.

FIG. 2 exemplarily illustrates a method for generating an opportunity match score implemented by an opportunity matching system on comparison of opportunity seeker skills of varying credibility with opportunity description skills of varying importance.

FIG. 3 exemplarily illustrates a flow diagram comprising the steps performed by the opportunity matching system for creating a unique skill list.

FIG. 4 exemplarily illustrates a flow diagram comprising the steps performed by the opportunity matching system for combining multiple occurrences of an opportunity seeker skill in a first skill list into a unique opportunity seeker skill.

FIG. 5 exemplarily illustrates a flow diagram comprising the steps performed by the opportunity matching system for computing a weighted skill amount measure and a weighted credibility measure for each opportunity seeker skill in sub-lists of skills present.

FIG. 6 exemplarily illustrates a flow diagram comprising the steps performed by the opportunity matching system for generating a unique opportunity seeker skill with a corresponding merged skill amount measure and a corresponding merged credibility measure.

FIG. 7 exemplarily illustrates a flow diagram comprising the steps performed by the opportunity matching system for combining the unique skill list and a second skill list of opportunity description skills to return a matched skill list.

FIG. 8 exemplarily illustrates a flow diagram comprising the steps performed by the opportunity matching system for generating a single matched skill from an opportunity description skill contained in the second skill list and the unique skill list.

FIG. 9 exemplarily illustrates a flow diagram comprising the steps performed by the opportunity matching system for generating an opportunity match score from the matched skill list.

FIG. 10 exemplarily illustrates a flow diagram comprising the steps performed by the opportunity matching system for generating an opportunity description skill in the matched skill list with an associated skill match score.

FIG. 11 exemplarily illustrates a flow diagram comprising the steps performed by the opportunity matching system for generating an opportunity match score.

FIGS. 12A-12Q exemplarily illustrate tabular representations of computations associated with opportunity seeker skills and opportunity description skills for determining a degree of match between opportunity seeker profiles with the opportunity seeker skills of varying credibility and opportunity descriptions with the opportunity description skills of varying importance.

FIGS. 13A-13N exemplarily illustrate an embodiment of tabular representations of computations associated with opportunity seeker skills and opportunity description skills for determining a degree of match between opportunity seeker profiles with the opportunity seeker skills of varying credibility and opportunity descriptions with the opportunity description skills of varying importance.

FIGS. 14A-14L exemplarily illustrate another embodiment of tabular representations of computations associated with opportunity seeker skills and opportunity description skills for determining a degree of match between opportunity seeker profiles with the opportunity seeker skills of varying credibility and opportunity descriptions with the opportunity description skills of varying importance.

FIG. 15 exemplarily illustrates a computer implemented system comprising the opportunity matching system for determining a degree of match between opportunity seeker profiles with opportunity seeker skills of varying credibility and opportunity descriptions with opportunity description skills of varying importance.

### DETAILED DESCRIPTION OF THE INVENTION

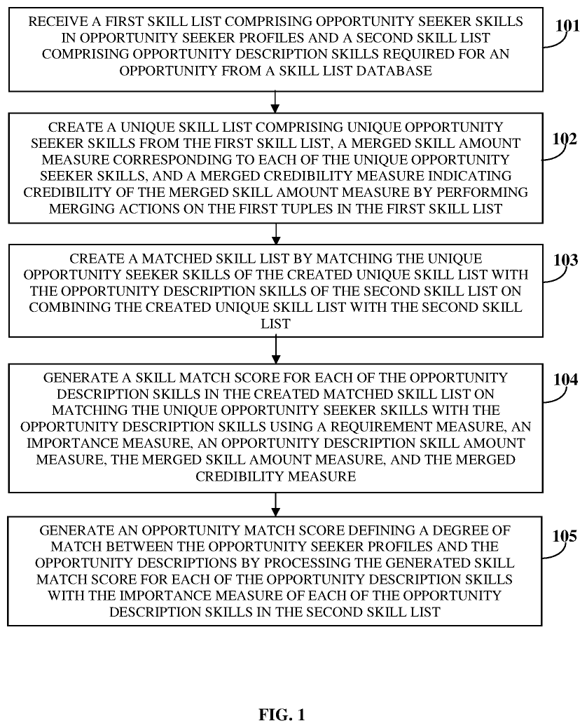

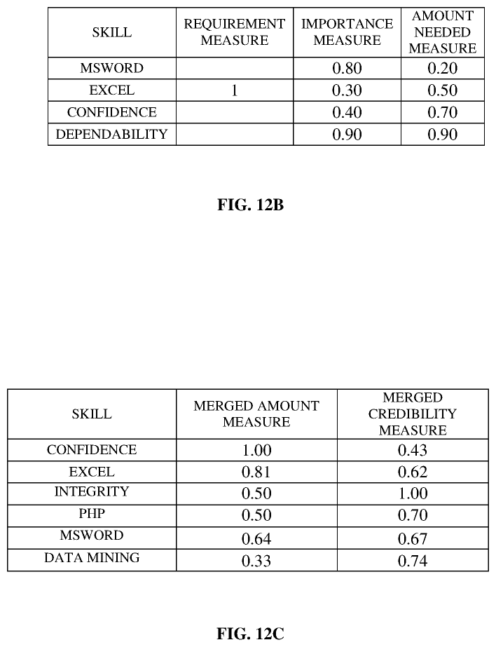

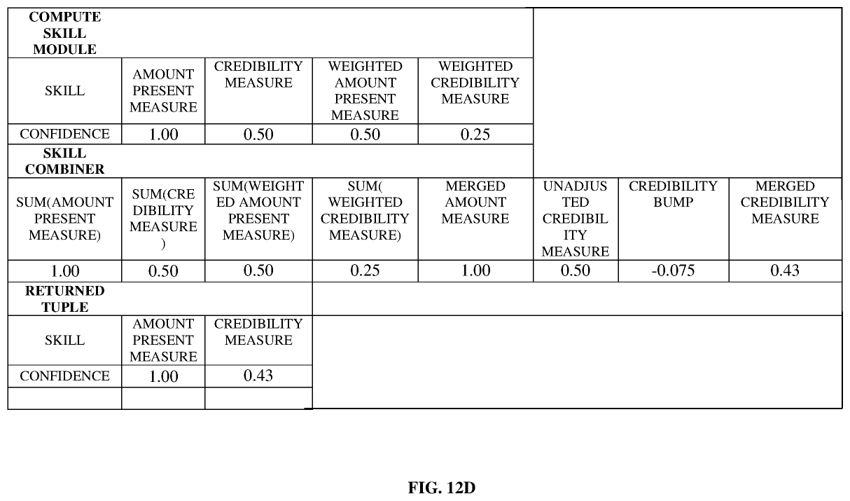

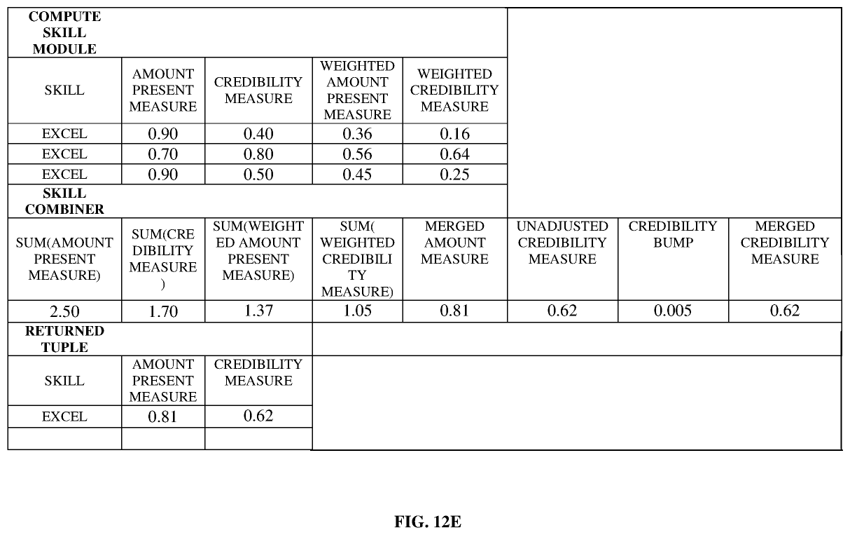

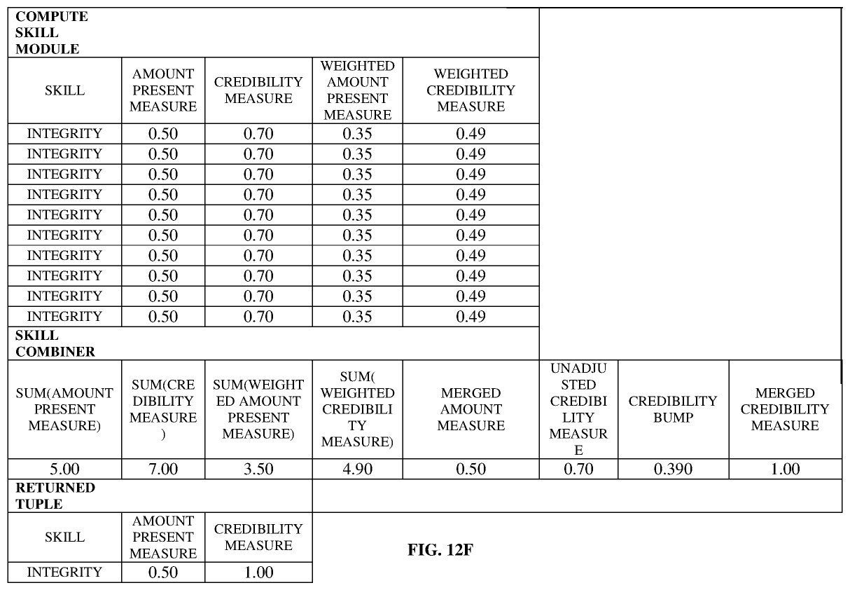

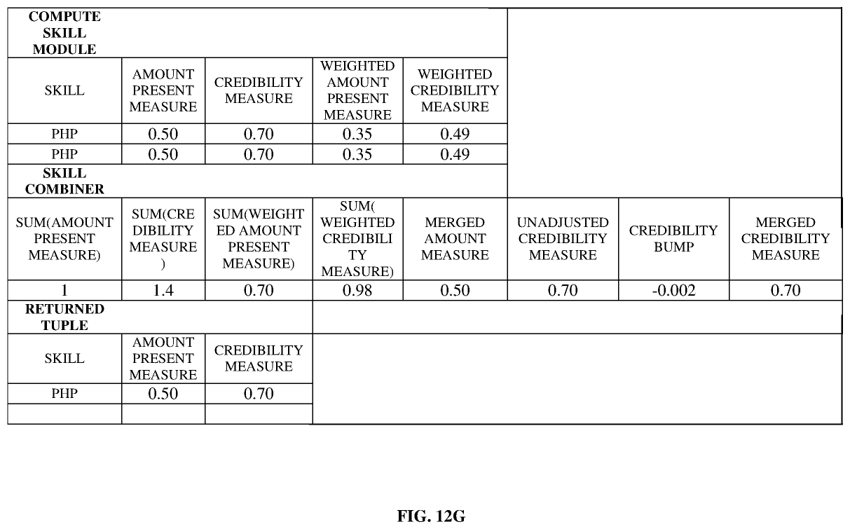

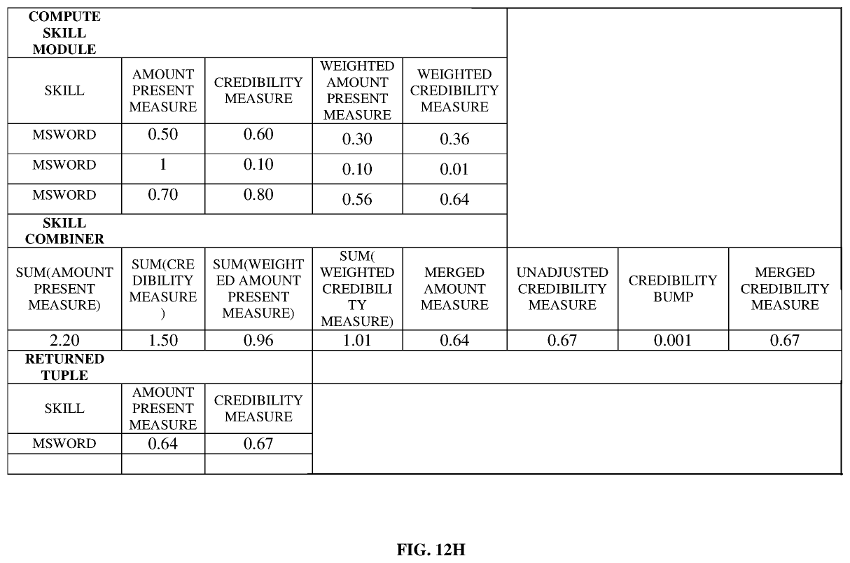

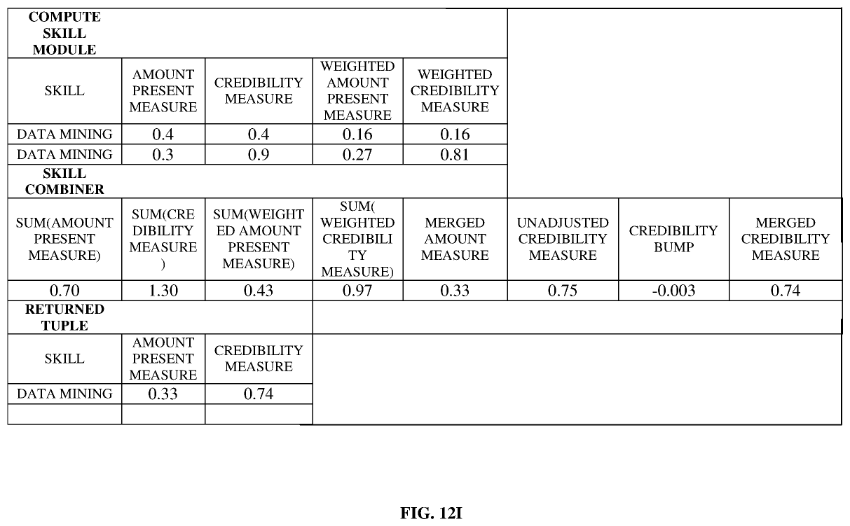

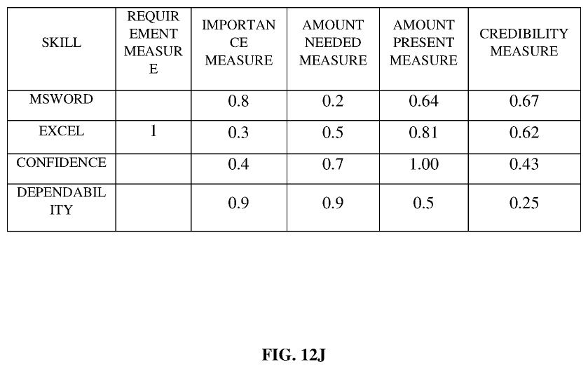

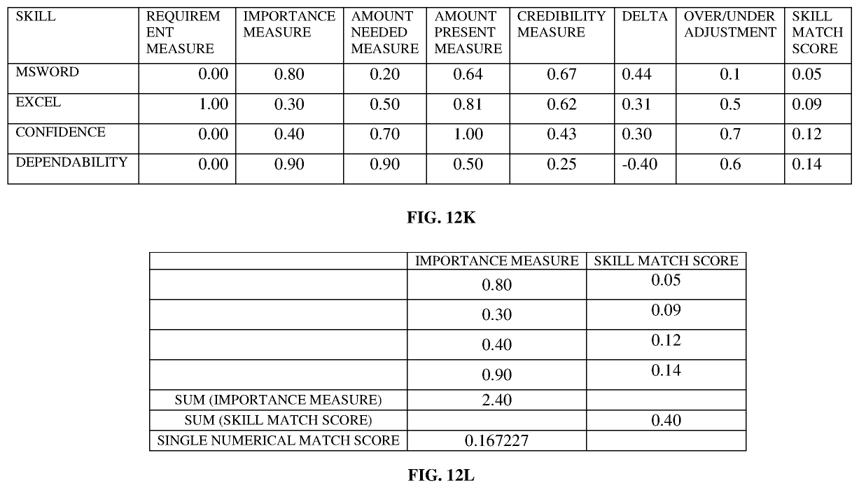

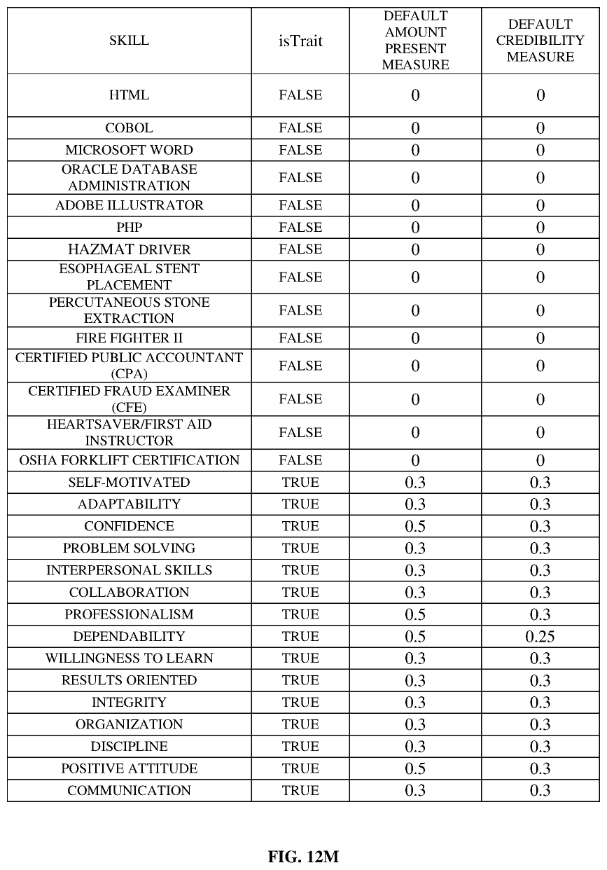

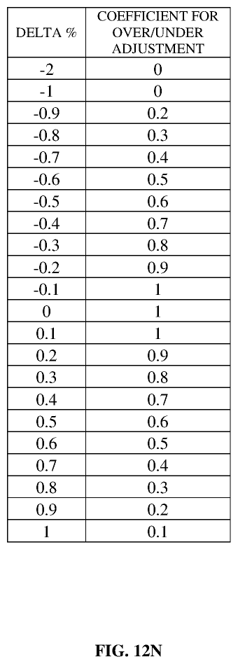

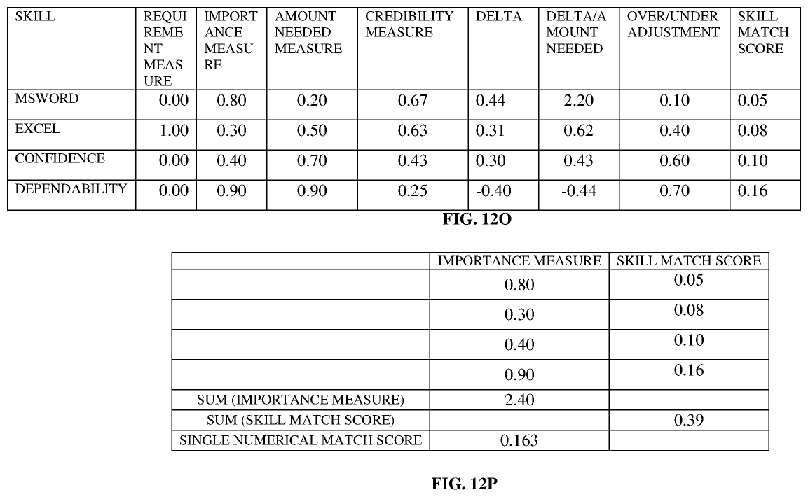

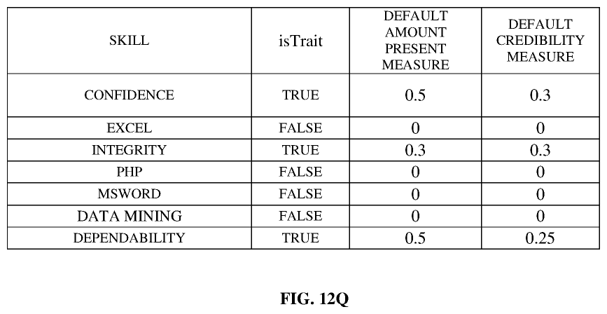

FIG. 1 illustrates a method for determining a degree of match between opportunity seeker profiles with opportunity seeker skills of varying credibility and opportunity descriptions with opportunity description skills of varying importance. As used herein, “opportunity seeker profiles” refers to profiles, for example, job profiles such as resumes or reviews of the opportunity seekers, and the opportunity seekers, for example, comprise an individual seeking a job, an employment, a work opportunity, etc. As used herein, “opportunity seeker skill” refers to expertise of an opportunity seeker in a particular domain for carrying out an opportunity smoothly and efficiently. The opportunity seeker skills comprise core personal traits and/or domains of expertise of the opportunity seeker. Also, as used herein, “opportunity description skill” refers to expertise desired from an opportunity seeker for carrying out an opportunity smoothly and efficiently. The method disclosed herein employs an opportunity matching system comprising at least one processor configured to execute computer program instructions for determining a degree of match between opportunity seeker profiles with opportunity seeker skills of varying credibility and opportunity descriptions with opportunity description skills of varying importance. A first skill list comprises the opportunity seeker skills and a second skill list comprises the opportunity description skills. The opportunity seeker skills and the opportunity description skills are stored in a skill list database by an operational system, for example, a recruitment system of entities such as offices, educational institutes, etc. In the skill list database, the opportunity seeker skills and the opportunity description skills are classified into core personal traits and domains of expertise of the opportunity seekers. As used herein, “core personal traits” refer to distinguishing qualities of the opportunity seekers. The core personal traits comprise, for example, dependability, integrity, confidence, etc. The core personal traits in the first skill list and the second skill list are flagged using an “isTrait” flag as exemplarily illustrated in FIG. 12M. The first skill list and the second skill list are stored in the skill list database. The opportunity seeker skills in the skill list database constitute the first skill list, and the opportunity description skills in the skill list database constitute the second skill list.

The first skill list is a list of the core personal traits and the domains of expertise of the opportunity seekers, stored in the skill list database, that the opportunity matching system matches to a list of core personal traits and domains of expertise needed for an opportunity that is stored in the second skill list. An opportunity seeker skill in the first skill list has a corresponding opportunity seeker skill amount measure and a corresponding credibility measure indicating the credibility of the opportunity seeker skill amount measure. The skills in the first skill list, for example, ratings, already have a credibility measure. The opportunity matching system uses the credibility measure as a weight and aggregates the credibility measure, but the opportunity matching system does not set the credibility of the individual ratings. From the opportunity seeker profiles, for example, job profiles such as resumes or reviews of the opportunity seekers, the operational system of an entity extracts the proficiency of the opportunity seekers in the opportunity seeker skills. As used herein, “opportunity seeker skill amount measure” refers to a quantized value of the extracted proficiency of the opportunity seekers in the opportunity seeker skills. The opportunity seeker skill amount measure is a numerical value between 0 and 1, both inclusive and NULL. The opportunity seeker skill amount measure represents a degree to which an opportunity seeker skill is present. A value of 1 of the opportunity seeker skill amount measure indicates that the opportunity seeker skill is present to a maximum level possible, that is, the opportunity seeker is highly proficient in the opportunity seeker skill. A value of 0 of the opportunity seeker skill amount measure indicates that the opportunity seeker skill is not present, that is, the opportunity seeker does not possess the opportunity seeker skill. A value of NULL of the opportunity seeker skill amount measure indicates that the opportunity seeker skill is not known. The opportunity seeker skill amount measure is a fraction of a total skill amount measure of the opportunity seeker skills possessed by the opportunity seekers. The core personal traits in the skill list database have corresponding default values for the opportunity seeker skill amount measure and the credibility measure. In an embodiment, the core personal traits in the skill list database do not have corresponding default values for the opportunity seeker skill amount measure and the credibility measure. In an embodiment, the skills in the skill list database have corresponding default values for the opportunity seeker skill amount measure and the credibility measure.

The operational system of an entity estimates the credibility of the opportunity seeker skill amount measure corresponding to the opportunity seeker skills, and assigns a credibility measure based on the estimated credibility to the opportunity seeker skill amount measure. The credibility measure refers to a numerical value between 0 and 1, both inclusive and NULL. The credibility measure represents the probability of the opportunity seeker skill amount measure being accurate. For example, an opportunity seeker skill amount measure for an entry, that is, an opportunity seeker skill, in the first skill list with a credibility of 0.9 is treated to represent that the opportunity seeker skill is actually present or is true 9 times out of 10. The credibility measure is a positive number less than 1 and represents the probability of the opportunity seeker skill amount measure being accurate. Furthermore, any particular opportunity seeker skill may be present multiple times with possibly different values for the opportunity seeker skill amount measure and the credibility measure in the first skill list.

An opportunity description skill in the second skill list has a corresponding opportunity description skill amount measure, a corresponding requirement measure, and a corresponding importance measure. As used herein, “opportunity description skill amount measure” refers to a quantized value of the proficiency of the opportunity seekers needed for the opportunity. The opportunity description skill amount measure is a numerical value between 0 and 1, both inclusive. The opportunity description skill amount measure represents the degree to which the opportunity description skill is required. A value of 1 of the opportunity description skill amount measure indicates that the opportunity description skill is needed to a maximum level possible, and a value of 0 of the opportunity description skill amount measure indicates that the opportunity description skill is not needed. A value, for example, of 0.2 of the opportunity description skill amount measure indicates that only 20% proficiency in the opportunity description skill is needed from the opportunity seekers for the opportunity.

Also, as used herein, “requirement measure” is a Boolean value associated with an opportunity description skill representing that the opportunity seeker skill amount measure of the opportunity seeker skill is required to be equal to the opportunity description skill amount measure of the opportunity description skill, where the opportunity description skill is the same as the opportunity seeker skill. The requirement measure is associated with opportunity description skills that are basic and mandatory for an opportunity, for example, licenses and certifications such as a medical license or a certified public accountant (CPA).

Also, as used herein, “importance measure” is a quantized value representing the degree to which the presence of an opportunity description skill in the first skill list is needed for an opportunity. That is, the importance measure is the weightage associated with an opportunity seeker skill for the opportunity. The importance measure is a numerical value between 0 and 1, both inclusive. An opportunity description skill with an importance measure of 0.1 is considered to be barely important for the opportunity, and an opportunity description skill with an importance measure of 0.9 is considered to be very important. The importance measure need not be considered as a hierarchy of needs.

In the method disclosed herein, the opportunity matching system receives 101 the first skill list comprising the opportunity seeker skills in the opportunity seeker profiles, and the second skill list comprising the opportunity description skills required for an opportunity from the skill list database. The first skill list comprises first tuples. Each of the first tuples comprises one of the opportunity seeker skills, the opportunity seeker skill amount measure corresponding to the opportunity seeker skill, and the credibility measure indicating credibility of the opportunity seeker skill amount measure. The second skill list comprises second tuples. Each of the second tuples comprises one of the opportunity description skills, the requirement measure, the importance measure, and the opportunity description skill amount measure associated with the opportunity description skill.

The opportunity matching system creates 102 a unique skill list comprising unique opportunity seeker skills from the first skill list, a merged skill amount measure corresponding to each of the unique opportunity seeker skills, and a merged credibility measure indicating credibility of the merged skill amount measure by performing merging actions on the first tuples in the first skill list. In performing the merging actions, the opportunity matching system computes the merged skill amount measure and the merged credibility measure corresponding to each of the unique opportunity seeker skills using the opportunity seeker skill amount measure and the credibility measure of each of the opportunity seeker skills of the first skill list as disclosed in the detailed description of FIGS. 12A-12N. As used herein, “unique opportunity seeker skills” refers to opportunity seeker skills with multiple occurrences in the first skill list that are merged to a single occurrence. Also, as used herein, a “merged skill amount measure” refers to a combined value of the opportunity seeker skill amount measures corresponding to the multiple occurrences of the opportunity seeker skills in the first skill list. Also, as used herein, a “merged credibility measure” refers to a combined value of the credibility measures corresponding to the multiple occurrences of the opportunity seeker skills in the first skill list.

The opportunity matching system merges multiple reports or occurrences of an opportunity seeker skill where the reports are of mixed credibility measures. The opportunity matching system determines a merged credibility measure of 0.13 for two reports of low credibility measures of 0.9 and two reports of high credibility measures of 0.1 indicating the reports with the low credibility measures have minimal impact on the merged credibility measure, instead of averaging out the credibility measures of 0.9 and 0.1 to a merged credibility measure of 0.5. Consider an example where 15 reports of an opportunity seeker skill amount measure of 0.80 of an opportunity seeker skill such as the hypertext preprocessor (PHP) programming language with a credibility measure of 0.50 are present in the first skill list, and 2 reports of another opportunity seeker skill with the same opportunity seeker skill amount measure and the same credibility measure are also present in the first skill list. The opportunity matching system determines, in the above example, that the 15 reports of the opportunity seeker skill amount measure of 0.80 for the PHP programming language with the credibility measure of 0.50 has a higher merged credibility measure than the 2 reports of another opportunity seeker skill with the same opportunity seeker skill amount measure and credibility measure.

The opportunity matching system creates 103 a matched skill list by matching the unique opportunity seeker skills of the created unique skill list with the opportunity description skills of the second skill list on combining the created unique skill list with the second skill list as disclosed in the detail description of FIGS. 12A-12N. The opportunity matching system generates 104 a skill match score for each of the opportunity description skills in the created matched skill list on matching the unique opportunity seeker skills with the opportunity description skills using the requirement measure, the importance measure, the opportunity description skill amount measure, the merged skill amount measure, and the merged credibility measure as disclosed in the detailed description of FIGS. 12A-12N. For the generation of the skill match score for each of the opportunity description skills, the opportunity matching system determines deviations in the merged skill amount measure and the opportunity description skill amount measure using an amount measure deviation lookup table. The amount measure deviation lookup table is used for determining the skill match score and expresses the skill match score in various ways.

Furthermore, the opportunity matching system generates 105 an opportunity match score defining the degree of match between the opportunity seeker profiles and the opportunity descriptions by processing the generated skill match score for each of the opportunity description skills with the importance measure of each of the opportunity description skills in the second skill list. The opportunity matching system also determines whether an opportunity description skill is absent in the created unique skill list and assigns default values to the merged skill amount measure and the merged credibility measure corresponding to the opportunity description skill in the matched skill list as disclosed in the detailed description of FIGS. 12A-12N.

In an embodiment, the opportunity matching system is used in an employment process. The opportunity matching system can be used for matching job seekers to jobs in the employment process. In an embodiment, the opportunity matching system is used for matching customers with certain opportunity seeker skills to a business. In an embodiment, the opportunity matching system is used for matching diners with certain opportunity seeker skills to a restaurant.

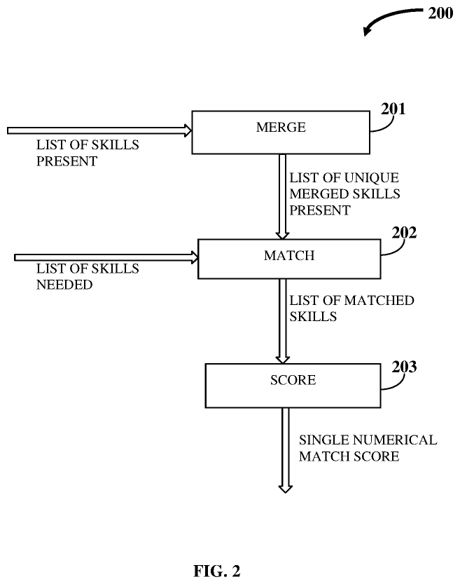

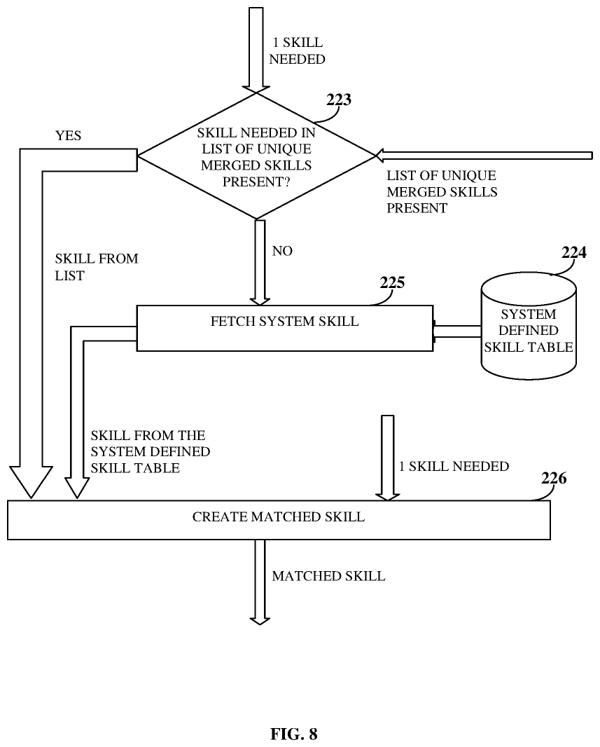

FIG. 2 exemplarily illustrates a method for generating an opportunity match score implemented by the opportunity matching system 200 on comparison of the opportunity seeker skills of varying credibility with the opportunity description skills of varying importance. As exemplarily illustrated in FIG. 2, the opportunity matching system 200 comprises a merging module 201, a matching module 202, and a score generation module 203. The merging module 201 performs merging actions on the opportunity seeker skills in a list of skills present, that is, the first skill list. The merging module 201 returns a list of unique merged skills present, that is, the unique skill list. The opportunity matching system 200 invokes the matching module 202 with the list of unique merged skills present and a list of skills needed, that is, the second skill list. The matching module 202 combines the list of unique merged skills present and the list of skills needed and returns a list of matched skill entries, that is, the matched skill list. The matching module 202 comprises a skill entry matching module 221, exemplarily illustrated in FIG. 7, for receiving the list of matched skill entries. The skill entry skill entry matching module 221 returns a list of matched skills. The opportunity matching system 200 invokes the score generation module 203 with the list of matched skills. The score generation module 203 returns a single numerical match score, that is, the opportunity match score.

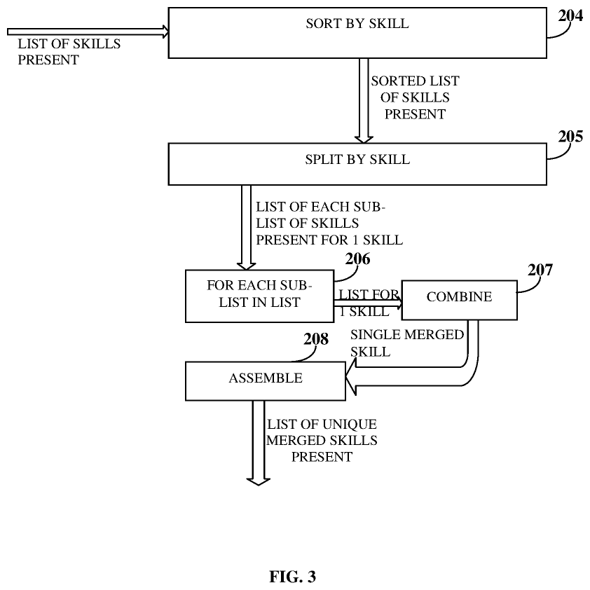

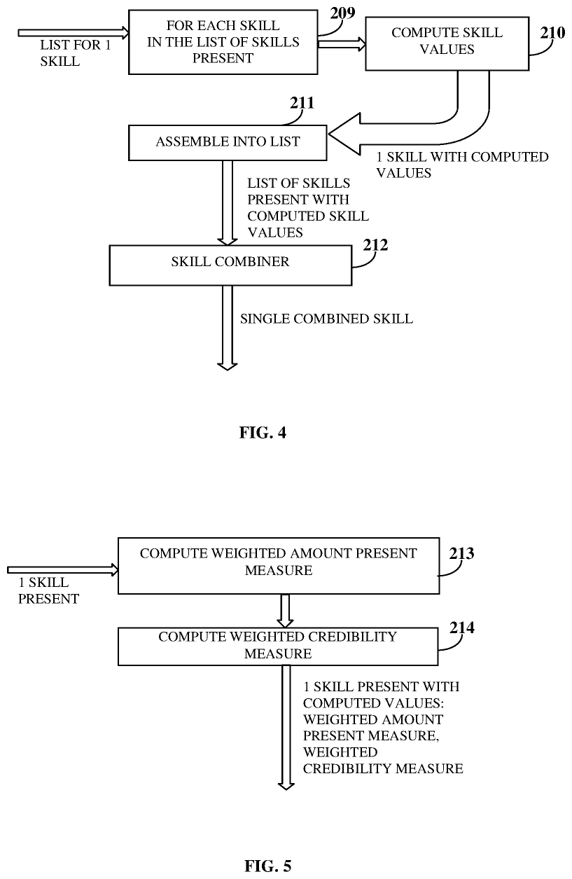

FIG. 3 exemplarily illustrates a flow diagram comprising the steps performed by the merging module 201 of the opportunity matching system 200 exemplarily illustrated in FIG. 2, for creating the list of unique merged skills present, that is, the unique skill list comprising the unique opportunity seeker skills, namely, the skills present, a corresponding merged skill amount measure, and a corresponding merged credibility measure. The merging module 201 combines multiple entries, that is, multiple occurrences of the opportunity seeker skills in the list of skills present into one entry per opportunity seeker skill in the list of unique merged skills present with a combined amount present measure, that is, the merged amount measure, and a combined credibility measure, that is, the merged credibility measure. The opportunity matching system 200 invokes the merging module 201 with a list of skills present. The merging module 201 sorts 204 the entries in the list of skills present by the opportunity seeker skills and then splits 205 the list of skills present into N sub-lists of skills present, where each sub-list of skills present contains entries for a common skill, that is, for a single opportunity seeker skill. The merging module 201 comprises a combining module 207 for generating a single merged skill, that is, a unique opportunity seeker skill from each of the N sub-lists of skills present 206 as disclosed in the detailed description of FIG. 4. The merging module 201 assembles 208 the unique opportunity seeker skill from each of the N sub-lists of skills present 206 into a new list of unique merged skills present. A list of the unique merged skills present, that is, the unique skill list is the output of the merging module 201.

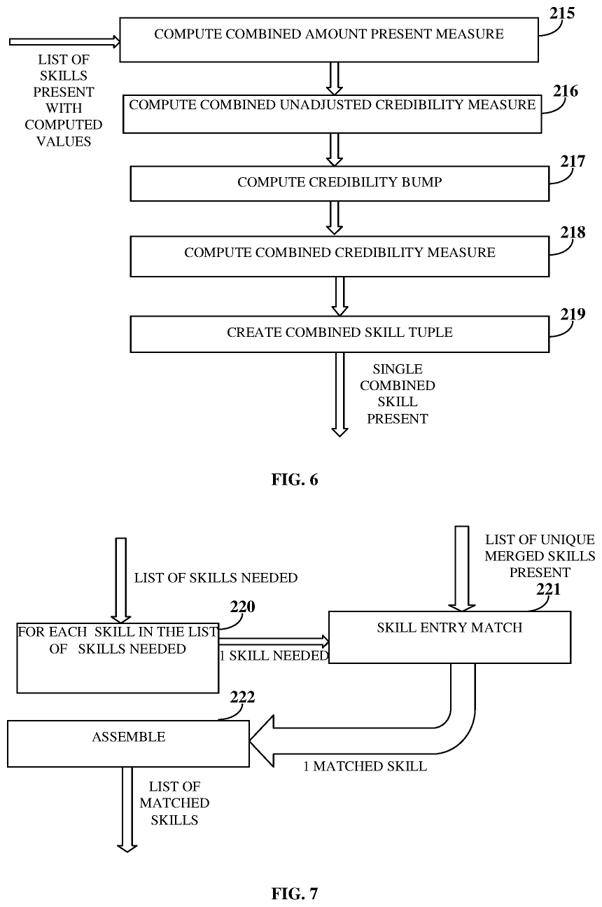

FIG. 4 exemplarily illustrates a flow diagram comprising the steps performed by the combining module 207 exemplarily illustrated in FIG. 3, of the opportunity matching system 200 exemplarily illustrated in FIG. 2, for combining multiple occurrences of the opportunity seeker skills in the first skill list, that is, the list of skills present into a single merged skill, that is, a unique opportunity seeker skill with a corresponding merged amount measure and a corresponding merged credibility measure. The opportunity matching system 200 invokes the combining module 207 with a sub-list of skills present 206 as disclosed in the detailed description of FIG. 3, such that each entry in the sub-list of skills present 206 is for the same opportunity seeker skill. In an embodiment, the N sub-list of skills present 206 comprises the opportunity seeker skills extracted by the operational system of an entity from different opportunity seeker profiles, for example, resume and reviews of opportunity seekers. The combining module 207 comprises a compute skill values module 210 and a skill combiner 212. The compute skill values module 210 computes skill values, that is, a weighted skill amount measure and a weighted credibility measure for each opportunity seeker skill in the N sub-lists of skills present 209 as disclosed in the detailed description of FIG. 5. The compute skill values module 210 adds values for the weighted skill amount measure and the weighted credibility measure to each opportunity seeker skill in the N sub-lists of skills present 206 to create tuples in the N sub-lists of skills present 206 as disclosed in the detailed description of FIG. 6. The values obtained from the compute skill values module 210 is then passed to a skill combiner 212 for further processing. The combining module 207 assembles 211 the single sub-list of skills present 206 comprising the opportunity seeker skills with corresponding computed skill values into a list. The skill combiner 212 returns a single merged or combined skill, that is, a unique opportunity seeker skill on combining the enhanced skills present tuples, that is, the tuples with the opportunity seeker skills and corresponding weighted skill amount measures and corresponding weighted credibility measures as disclosed in the detailed description of FIG. 6.

FIG. 5 exemplarily illustrates a flow diagram comprising the steps performed by the opportunity matching system 200 exemplarily illustrated in FIG. 2, for computing skill values, that is, a weighted skill amount measure and a weighted credibility measure for each opportunity seeker skill in the N sub-lists of skills present 206 exemplarily illustrated in FIG. 3. The compute skill values module 210 computes 213 a weighted amount present measure as skill amount measure*credibility measure of the opportunity seeker skill. The compute skill values module 210 computes 214 a weighted credibility measure as credibility measure*credibility measure of the opportunity seeker skill. The compute skill values module 210 returns an opportunity seeker skill in the sub-list of skills present 206 with the computed values of the weighted amount present measure and the weighted credibility measure.

In the computation of the weighted amount present measures and the weighted credibility measures of the opportunity seeker skills in the N sub-list of skills present 206, the credibility measures affect the weightage provided to the opportunity seeker skill amount measures of the opportunity seeker skills in the N sub-list of skills present 206. The credibility measures also affect the weightage provided to the credibility measures. A sum of the weighted credibility measures of an opportunity seeker skill in a sub-list of skills present 206 is used to calculate a credibility adjustment, that is, a credibility bump that is added to an unadjusted credibility measure to generate a merged credibility measure of the opportunity seeker skill based on the number of reports and the credibility of the corresponding reports as disclosed in the detailed description of FIG. 6.

FIG. 6 exemplarily illustrates a flow diagram comprising the steps performed by the opportunity matching system 200 exemplarily illustrated in FIG. 2, for generating a unique opportunity seeker skill with a corresponding merged skill amount measure and a corresponding merged credibility measure. The skill combiner 212 exemplarily illustrated in FIG. 4, receives a sub-list of skills present 206 exemplarily illustrated in FIG. 3, with the computed values of the weighted amount present measure and the weighted credibility measure and creates a single combined skill, that is, a unique opportunity seeker skill. The opportunity matching system 200 invokes the skill combiner 212 with a sub-list of skills present 206 with computed values such that all entries in the sub-list of skills present 206 are for the same opportunity seeker skill. The skill combiner 212 computes 215 an amount present measure, that is, the merged skill amount measure as Sum(weighted amount present measure)/Sum(credibility measure). The skill combiner 212 computes 216 a combined unadjusted credibility measure as Sum(weighted credibility measure)/Sum(credibility measure). The skill combiner 212 computes 217 a credibility bump as (Sum(weighted credibility measure)*coeff_credbump)˜coeff_credbump, where the coefficient coeff_credbump is a predefined constant. The skill combiner 212 computes 218 a credibility measure, that is, the merged credibility measure, as (combined unadjusted credibility measure+credibility bump) that is adjusted to have a minimum value of 0 and a maximum value of 1. The skill combiner 212 creates 219 a combined skill tuple, that is, a tuple in the unique skill list, comprising the unique opportunity seeker skill being the skill from the sub-list of the skills present with the computed combined amount present measure and the computed combined credibility measure. The skill combiner 212 returns a single merged skill or a combined skill, that is, the unique opportunity seeker skill. The merging module 201 assembles 208 the unique opportunity seeker skill from each of the N sub-lists of skills present 206 into the unique skill list, that is, the list of unique merged skills present as disclosed in the detailed description of FIG. 3.

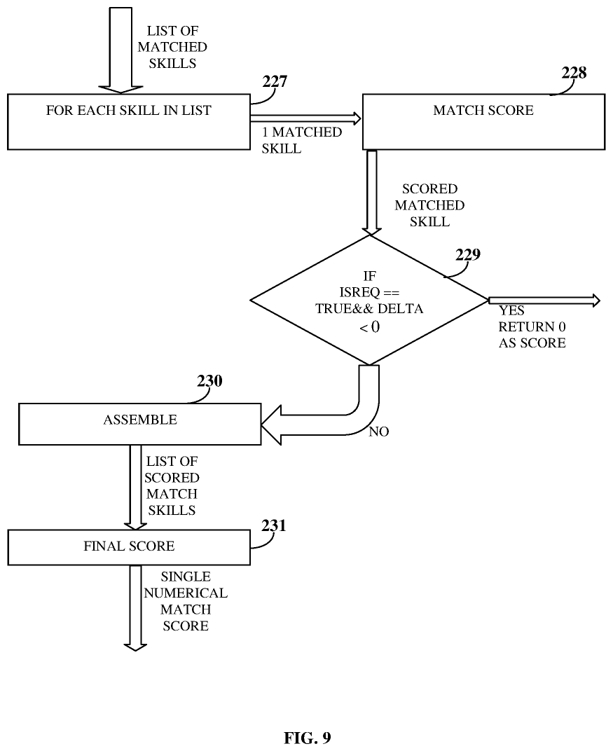

FIG. 7 exemplarily illustrates a flow diagram comprising the steps performed by the opportunity matching system 200 exemplarily illustrated in FIG. 2, for combining the unique skill list, that is, the list of unique merged skills present and the second skill list, that is, the list of skills needed to return a list of matched skills, that is, the matched skill list. For each skill in the list of skills needed 220, the opportunity matching system 200 invokes the skill entry matching module 221 with the list of unique merged skills present and a single skill from the list of skills needed. The skill entry matching module 221 returns a single matched skill that is assembled 222 into the list of matched skills, that is, the matched skill list as disclosed in the detailed description of FIG. 8.

FIG. 8 exemplarily illustrates a flow diagram comprising the steps performed by the opportunity matching system 200 exemplarily illustrated in FIG. 2, for generating a single matched skill from a skill needed, that is, the opportunity description skill contained in the list of skills needed, that is, the second skill list and a list of unique merged skills present, that is, the unique skill list. The skill entry matching module 221 exemplarily illustrated in FIG. 7, examines 223 whether the list of unique merged skills present contains the skill needed, that is, the opportunity description skill. If the opportunity description skill is present in the list of unique merged skills present, the skill entry matching module 221 passes the unique opportunity seeker skill that is the same as the opportunity description skill as a skill_present to a create matched skill module 226. If the opportunity description skill is absent in the list of unique merged skills present, the skill entry matching module 221 fetches 225 the corresponding skill definition from the predefined skill table 224, that is, the skill list database exemplarily illustrated in FIG. 12M and passes to the create matched skill module 226 as a skill_present made with the default amount present measure from the skill definition as the merged amount measure, and with the default credibility measure from the skill definition as the merged credibility measure. The default values of amount present measure and the credibility measure are set to 0. The opportunity description skills and the opportunity seeker skills in the predefined skill table 224 comprise domains of expertise and core personal traits of the opportunity seekers. The core personal traits, as exemplarily illustrated in FIG. 12M, are indicated by an ISTRAIT flag. The processing of the opportunity seeker skill amount measure and the credibility measure for a core personal trait by the opportunity matching system 200 is the same as the processing of the opportunity seeker skill amount measure and the credibility measure for a domain of expertise. The create matched skill module 226 accepts the skill_present and the opportunity description skill and creates a matched skill tuple comprising an opportunity description skill amount measure, an importance measure, and a requirement measure of the opportunity description skill and a merged skill amount measure and a merged credibility measure of the skill_present.

FIG. 9 exemplarily illustrates a flow diagram comprising the steps performed by the score generation module 203 of the opportunity matching system 200 exemplarily illustrated in FIG. 2, for generating a single numerical match score, that is, the opportunity match score from a list of matched skills, that is, the matched skill list. The opportunity matching system 200 invokes the score generation module 203 exemplarily illustrated in FIG. 2, with the list of matched skills as disclosed in the detailed description of FIG. 2. In step 227, each matched skill, that is, a unique opportunity seeker skill matched with an opportunity description skill from the matched skill list is passed to a match score generation module 228 that adds to each matched skill, additional values of a delta and a match score and generates a scored matched skill. The score generation module 203 examines 229 whether the matched skill has an ISREQ value, that is, a requirement measure of TRUE in the second skill list, and whether a deviation, the delta, is less than zero. If the matched skill has an ISREQ value of TRUE and if the delta is less than zero, the score generation module 203 returns a final numerical score, that is, the opportunity match score of zero regardless of any other processing. If the matched skill does not have an ISREQ value of TRUE and if the delta is more than zero, the score generation module 203 assembles 230 the scored matched skills, that is, the matched skills in the matched skill list with associated skill match scores into a list and passes the list to a final score generation module 231 that returns the single numerical match score.

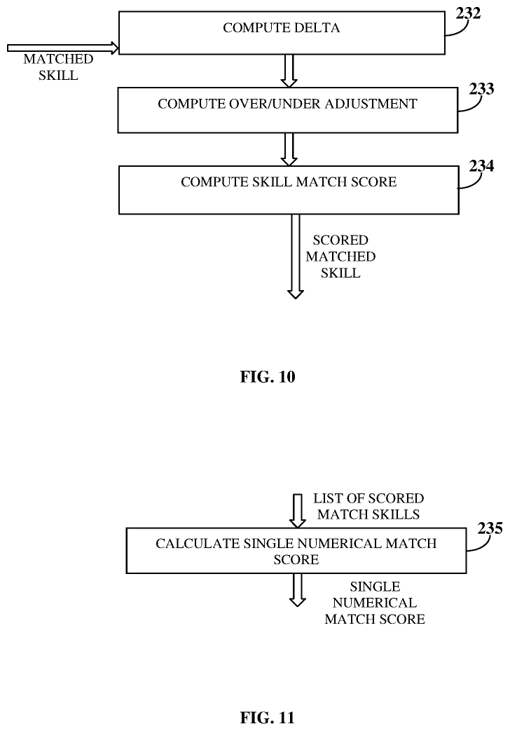

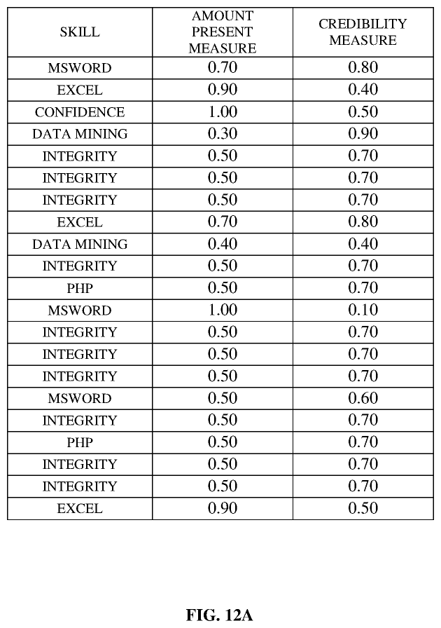

FIG. 10 exemplarily illustrates a flow diagram comprising the steps performed by the opportunity matching system 200 exemplarily illustrated in FIG. 2, for generating a scored match skill, that is, an opportunity description skill in the matched skill list with an associated skill match score. The match score generation module 228 exemplarily illustrated in FIG. 9, receives the matched skill, that is, the opportunity description skill matching with an opportunity seeker skill in the matched skill list. The match score generation module 228 computes 232 the delta as the difference in the merged skill amount measure, Amount_Present, and opportunity description skill amount measure, Amount_Needed. That is, the match score generation module 228 determines the deviation in the merged skill amount measure and the opportunity description skill amount measure as disclosed in the detailed description of FIG. 1. The match score generation module 228 computes 233 an over/under adjustment using a lookup of (delta/Amount_Needed) against an amount measure deviation lookup table exemplarily illustrated in FIG. 12N, that returns a numerical value for different data ranges of the value of the (delta/Amount_Needed). The match score generation module 228 further computes 234 a skill match score as (importance measure*credibility measure*over/under adjustment) for each matched skill. The match score generation module 228 adds additional values of delta and skill match score to each of the matched skills and generates scored matched skills as disclosed in the detailed description of FIG. 9.

FIG. 11 exemplarily illustrates a flow diagram comprising the steps performed by the opportunity matching system 200 exemplarily illustrated in FIG. 2, for generating an opportunity matching score, that is, a single numerical match score for the scored matched skills. The opportunity matching system 200 invokes a final score generation module 231 exemplarily illustrated in FIG. 9, with a list of scored matched skills, that is, the matched skills in the matched skill list with associated skill match scores. The final score generation module 231 calculates 235 a single numerical match score as Sum(skill match score)/Sum(importance measure). The single numerical match score determines the degree of match between the opportunity description skills and the opportunity seeker skills.

In an embodiment, the skill list database is a relational database. The amount measure deviation lookup table and the predefined skill table 224 exemplarily illustrated in FIG. 8, in an embodiment, form a part of a relational database. The amount measure deviation lookup table and the predefined skill table 224, in an embodiment, are flat files. The skill list database, in an embodiment, is a persistent data store.

The limitations recited in the independent claims are not well-understood, routine or conventional activities widely prevalent or in common use in the human resources industry. Accordingly, the independent claims amount to significantly more than an abstract idea. The data input to the computer by the user is technically transformed, processed, and executed by an algorithm in the computer program to achieve the final step of the invention as recited in the independent claims.

FIGS. 12A-12N exemplarily illustrate tabular representations of computations associated with opportunity seeker skills and opportunity description skills for determining a degree of match between opportunity seeker profiles with the opportunity seeker skills of varying credibility and opportunity descriptions with the opportunity description skills of varying importance. FIG. 12A exemplarily illustrates a first skill list comprising opportunity seeker skills, for example, MS Word, Excel, confidence, data mining, integrity, hypertext preprocessor (PHP) programming language, etc., extracted from job profiles, for example, resumes and reviews of the opportunity seekers. The opportunity seeker skills, for example, confidence, integrity, etc., are core personal traits, and the opportunity seeker skills, for example, MS Word, PHP programming language, data mining, etc., are domains of expertise of the opportunity seekers. As exemplarily illustrated in FIG. 12A, the first skill list comprises multiple occurrences of the opportunity seeker skills in random with corresponding skill amount measures and corresponding credibility measures. The opportunity matching system 200 receives the first skill list exemplarily illustrated in FIG. 12A, comprising the opportunity seeker skills from a skill list database. The first skill list comprises first tuples and each of the first tuples comprises an opportunity seeker skill, an opportunity seeker skill amount measure corresponding to the opportunity seeker skill, and a credibility measure indicating credibility of the opportunity seeker skill amount measure. As exemplarily illustrated in FIG. 12A, a first tuple in the first skill list comprises an opportunity seeker skill, for example, CONFIDENCE, the opportunity seeker skill amount measure, that is, an amount present measure of 1.0, and a credibility measure of 0.50. Another first tuple in the first skill list comprises EXCEL as an opportunity seeker skill with a corresponding amount present measure of 0.90 and a corresponding credibility measure of 0.40. The first skill list comprises multiple first tuples comprising MSWORD as an opportunity seeker skill with corresponding amount present measures and corresponding credibility measures.

FIG. 12B exemplarily illustrates a second skill list comprising opportunity description skills required for an opportunity. The second skill list comprises second tuples and each of the second tuples comprises an opportunity description skill, an opportunity description skill amount measure corresponding to the opportunity description skill, a requirement measure, and an importance measure associated with the opportunity description skill. As exemplarily illustrated in FIG. 12B, a second tuple in the second skill list comprises an opportunity description skill, for example, MSWORD, a requirement measurement, that is, ISREQ value of NULL, an importance measure of 0.8, and an opportunity description skill amount measure, that is, an amount needed measure of 0.20. Another second tuple comprises, for example, EXCEL as an opportunity description skill with a corresponding requirement measure of 1, an importance measure of 0.30, and an amount needed measure of 0.50. The opportunity matching system 200 receives the second skill list exemplarily illustrated in FIG. 12B, from the skill list database.

FIG. 12C exemplarily illustrates a unique skill list created from the first skill list exemplarily illustrated in FIG. 12A, by the opportunity matching system 200. The opportunity matching system 200 performs merging actions, that is, splitting and sorting of the first tuples of the first skill list and computes a merged skill amount measure, that is, the merged amount measure, and a merged credibility measure as exemplarily illustrated in FIGS. 12D-12I. FIGS. 12D-12I exemplarily illustrate 6 sub-lists of the opportunity seeker skills that are in the first skill list exemplarily illustrated in FIG. 12A. As exemplarily illustrated in FIG. 12D, the merging module 201 of the opportunity matching system 200 exemplarily illustrated in FIG. 2, creates a sub-list of the opportunity seeker skill, CONFIDENCE, with a corresponding amount present measure, that is, the opportunity seeker skill amount measure of 1.00 and the corresponding credibility measure of 0.50. The compute skill values module 210 exemplarily illustrated in FIG. 4, determines a weighted amount present measure, that is, a weighted skill amount measure as skill amount measure*credibility measure=1.00*0.50=0.50, and a weighted credibility measure as credibility measure*credibility measure=0.50*0.50=0.25. The skill combiner 212 exemplarily illustrated in FIG. 4, computes a merged amount measure, that is, a merged skill amount measure as Sum(weighted amount present measure)/Sum(credibility measure). Since there is only one occurrence of the opportunity seeker skill CONFIDENCE in the sub-list, the Sum(amount present measure)=1.00, the Sum(weighted amount present measure)=0.50, and the Sum(credibility measure)=0.50. The skill combiner 212 computes the merged skill amount measure as 0.50/0.50=1.00 and an unadjusted credibility measure as Sum(weighted credibility measure)/Sum(credibility measure)=0.25/0.5=0.5. The skill combiner 212 computes the credibility bump as (Sum(weighted credibility measure)*coeff_credbump) −coeff_credbump. The coeff_credbump is a constant preconfigured in the skill combiner 212 as 0.1. The coeff_credbump defines the amount of credibility bump to provide to the N sub-lists. The coeff_credbump drives computations performed by the skill combiner 212, affecting degree of adjustment to be made to the credibility measure. The skill combiner 212 computes the credibility bump as (0.25*0.1)−0.1=−0.075. The skill combiner 212 computes the merged credibility measure as (unadjusted credibility measure+credibility bump)=0.5−0.075=0.425˜0.43.

Similarly, the merging module 201 of the opportunity matching system 200 exemplarily illustrated in FIG. 2, creates a sub-list of the opportunity seeker skill, EXCEL, with corresponding amount present measures 0.90, 0.70, and 0.90 and credibility measures of 0.40, 0.80, and 0.50 as exemplarily illustrated in FIG. 12E. The compute skill values module 210 determines a weighted amount present measure as skill amount measure*credibility measure and a weighted credibility measure as credibility measure*credibility measure for each of the occurrences of the opportunity seeker skill, EXCEL, in the sub-list. The weighted amount present measure is computed as 0.36, 0.56, and 0.45 and the weighted credibility measure is computed as 0.16, 0.64, and 0.25 respectively for the three occurrences of the opportunity seeker skill, EXCEL, in the sub-list. The skill combiner 212 computes a merged skill amount measure as Sum(weighted amount present measure)/Sum(credibility measure). Sum(weighted amount present measure)=1.37, Sum(credibility measure)=1.70, and Sum(weighted credibility measure)=1.05. The skill combiner 212 computes the merged skill amount measure as 1.37/1.7=0.805˜0.81 and the unadjusted credibility measure as Sum(weighted credibility measure)/Sum(credibility measure)=1.05/1.7=0.62. The skill combiner 212 computes the credibility bump as (Sum(weighted credibility measure)*coeff_credbump)−coeff_credbump with the coeff_credbump as 0.1. The skill combiner 212 computes the credibility bump as (1.05*0.1)−0.1=0.005. The skill combiner 212 computes the merged credibility measure as (unadjusted credibility measure+credibility bump)=0.62+0.005=0.625˜0.62.

As exemplarily illustrated in FIG. 12F, a sub-list of 10 reports or occurrences of the opportunity seeker skill, INTEGRITY, with corresponding amount present measures of 0.50 and corresponding credibility measures of 0.70 is created. The skill combiner 212 computes a merged skill amount measure and a merged credibility measure as disclosed in the detailed description of FIGS. 12D-12E, as 0.50 and 1.00. Similarly, in FIG. 12G, a sub-list of 2 reports of the opportunity seeker skill, PHP, with corresponding amount present measures of 0.50 and credibility measures of 0.70 is created. The skill combiner 212 computes a merged skill amount measure and a merged credibility measure as disclosed in the detailed description of FIGS. 12D-12E, as 0.50 and 0.70. As exemplarily illustrated in FIGS. 12F-12G, the opportunity seeker skill INTEGRITY with 10 reports of the skill amount measure 0.50 has more merged credibility measure than 2 reports of the opportunity seeker skill PHP with 2 reports of skill amount measure 0.50. A credibility bump lowers credibility of few reports of low credibility measures, and increases credibility of reports of large credibility measures. The credibility bump is between 0 and 1 and smaller values of credibility bump means more unadjusted credibility measure is needed to get a positive merged credibility measure. For a lower credibility measure, the number of occurrences of the opportunity seeker skill in the sub-list, that is, rows needed to obtain a positive credibility bump is more for a coeff_credbump=0.1 For a credibility measure of 1.00, 1 report is sufficient to obtain a positive credibility bump. For a credibility measure of 0.8, 2 reports are sufficient to obtain a positive credibility bump. For a credibility measure of 0.6, 3 reports are sufficient to obtain a positive credibility bump. For a credibility measure of 0.4, 10 reports are sufficient to obtain a positive credibility bump. For a credibility measure of 0.2, more than 20 reports are sufficient to obtain a positive credibility bump. For a credibility measure of 0.1, 100 reports are sufficient to obtain a positive credibility bump. The merging module 201 of the opportunity matching system 200 determines the merged skill amount measure and the merged credibility measure for the remaining opportunity seeker skills in the first skill list, exemplarily illustrated in FIG. 12A, as exemplarily illustrated in FIGS. 12F-12I, and creates the unique skill list as exemplarily illustrated in FIG. 12C.

FIG. 12J exemplarily illustrates a matched skill list created by the opportunity matching system 200 by matching the unique opportunity seeker skills in the unique skill list exemplarily illustrated in FIG. 12C, with the opportunity description skills in the second skill list exemplarily illustrated in FIG. 12B. The opportunity description skill, DEPENDABILITY, in the second skill list exemplarily illustrated in FIG. 12B, is absent in the unique skill list exemplarily illustrated in FIG. 12C. The skill entry matching module 221 exemplarily illustrated in FIG. 7, fetches the corresponding skill definition, that is, the skill needed, from the predefined skill table 224 exemplarily illustrated in FIG. 8 and FIG. 12M, along with a corresponding default amount present measure and a default credibility measure. The skill entry matching module 221 creates a skill present entry with the amount present measure and the credibility measure as 0.5 and 0.25 respectively, from the predefined skill table 224, that is, the skill list database exemplarily illustrated in FIG. 12M.

FIG. 12K exemplarily illustrates the matched skill list exemplarily illustrated in FIG. 12J, comprising skill match scores generated by the score generation module 203 of the opportunity matching system 200 exemplarily illustrated in FIG. 2, on matching the unique opportunity seeker skills in the unique skill list exemplarily illustrated in FIG. 12C, with the opportunity description skills in the second skill list exemplarily illustrated in FIG. 12B. The match score generation module 228, exemplarily illustrated in FIG. 9, adds to each matched skill, additional values of delta and determines the skill match score, that is, the row match score using an over/under adjustment. The over/under adjustment is a conventional lookup, for example, performed by a VLOOKUP function in MS Excel® of Microsoft Corporation. The over/under adjustment is used for downgrading or penalizing matches with large differences between the unique opportunity seeker skills and the opportunity description skills. Consider an example of an oral surgeon with 100% dental skills whose dental skills are underutilized in a dental hygienist job since the dental hygienist job needs only 10% dental skills. The oral surgeon may quickly leave the position of a dental hygienist if the oral surgeon finds another position that requires more dental skills. The match score generation module 228 fetches an overskilled adjustment from an amount measure deviation lookup table exemplarily illustrated in FIG. 12N, as 0.1 and the row match score is computed to be low, indicating the oral surgeon is not a match for a dental hygienist job. Consider another example of a dental hygienist with 10% dental skills whose dental skills are insufficient for a role of an oral surgeon since the role of oral surgeon requires 100% dental skills. If placed in the job of an oral surgeon, the dental hygienist may soon be dismissed due to the inability of the dental hygienist to perform the needed job activities of an oral surgeon. The match score generation module 228 fetches an underskilled adjustment from the amount measure deviation lookup table as 0.1 and the row match score is computed to be low, indicating the dental hygienist is not a match for the role of the oral surgeon. If the opportunity seeker skill is close to the opportunity description skill, over or under, the over/under adjustments are closer to 1 or equal to 1, making the row match score high between the opportunity seeker skill and the opportunity description skill as the importance measure of the opportunity description skill and the credibility measure of the opportunity seeker skill allow.

The match score generation module 228 computes delta as difference in a skill amount present measure and a skill amount needed measure. As exemplarily illustrated in FIG. 12K, the delta for the matched skill, DEPENDABILITY, is 0.50−0.90=−0.40. The match score generation module 228 determines an over/under adjustment using a lookup of (delta/skill amount needed measure) against the amount measure deviation lookup table exemplarily illustrated in FIG. 12N. The value of (delta/skill amount needed measure)=−0.40/0.90=−0.44˜−0.5. The corresponding over/under adjustment from the amount measure deviation lookup table is 0.6. The match score generation module 228 computes the skill match score as (importance measure*credibility measure*over/under adjustment)=0.90*0.25*0.60=0.135˜0.14 as exemplarily illustrated in FIG. 12K. Similarly, for the other matched skills, the match score generation module 228 computes the skill match scores as 0.05, 0.09, and 0.12 for the matched skills MSWORD, EXCEL, and CONFIDENCE respectively.

FIG. 12L exemplarily illustrates a tabular representation for generation of an opportunity match score defining the degree of match between the opportunity seeker profiles and the opportunity descriptions by the final score generation module 231 exemplarily illustrated in FIG. 9. The final score generation module 231 calculates a single numerical match score, that is, the opportunity match score, as Sum(skill match score)/Sum(importance measure)=(0.05+0.09+0.12+0.14)/(0.8+0.3+0.4+0.9)=0.40/2.40=0.1672˜0.17.

FIG. 12O exemplarily illustrates another embodiment of the matched skill list exemplarily illustrated in FIG. 12J, comprising skill match scores generated by the score generation module 203 of the opportunity matching system 200 exemplarily illustrated in FIG. 2, on matching the unique opportunity seeker skills in the unique skill list exemplarily illustrated in FIG. 12C, with the opportunity description skills in the second skill list exemplarily illustrated in FIG. 12B. The match score generation module 228 computes delta as difference in a skill amount present measure and a skill amount needed measure. As exemplarily illustrated in FIG. 12K, the delta for the matched skill, MSWORD, is 0.64−0.20=0.44. The match score generation module 228 determines an over/under adjustment using a lookup of (delta/skill amount needed measure) against the amount measure deviation lookup table exemplarily illustrated in FIG. 12N. The value of (delta/skill amount needed measure)=0.44/0.20=2.20. The corresponding over/under adjustment from the amount measure deviation lookup table is 0.10. The match score generation module 228 computes the skill match score as (importance measure*credibility measure*over/under adjustment)=0.80*0.67*0.10=0.054˜0.05 as exemplarily illustrated in FIG. 12K. Similarly, for the other matched skills, the match score generation module 228 computes the skill match scores as 0.08, 0.10, and 0.16 for the matched skills EXCEL, CONFIDENCE, and DEPENDABILITY respectively.

FIG. 12P exemplarily illustrates another embodiment of a tabular representation for generation of an opportunity match score defining the degree of match between the opportunity seeker profiles and the opportunity descriptions by the final score generation module 231 exemplarily illustrated in FIG. 9. The final score generation module 231 calculates a single numerical match score, that is, the opportunity match score, as the Sum(skill match score)/Sum(importance measure)=(0.05+0.08+0.10+0.16)/(0.80+0.30+0.40+0.90)=0.39/2.40=0.163˜0.16. The single numerical match score of 0.163 is different than 0.098 which is the simple average of the skill match score without using importance as a weight.

FIG. 12Q exemplarily illustrates another embodiment of a tabular representation of the default amount pressure and the default credibility measure. For example, the opportunity seeker skill of CONFIDENCE, if the isTrait representation is TRUE, the default amount measure is 0.5 and the corresponding credibility measure is 0.3. The opportunity seeker skill of INTEGRITY, if the isTrait representation is TRUE, the default amount measure is 0.3 and the corresponding credibility measure is 0.3.

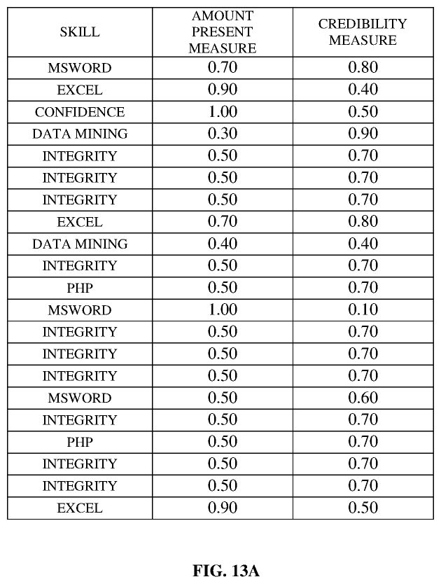

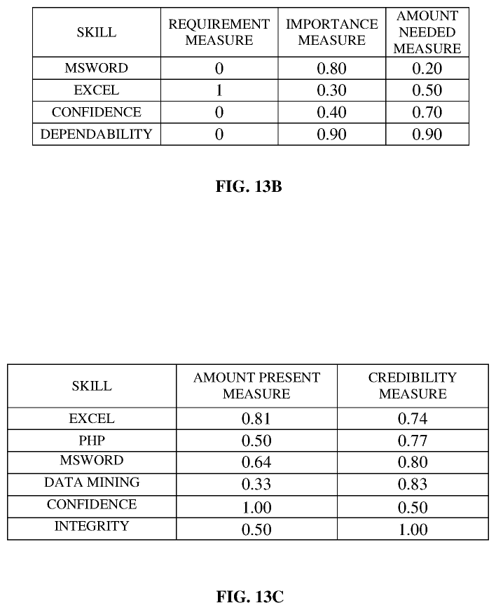

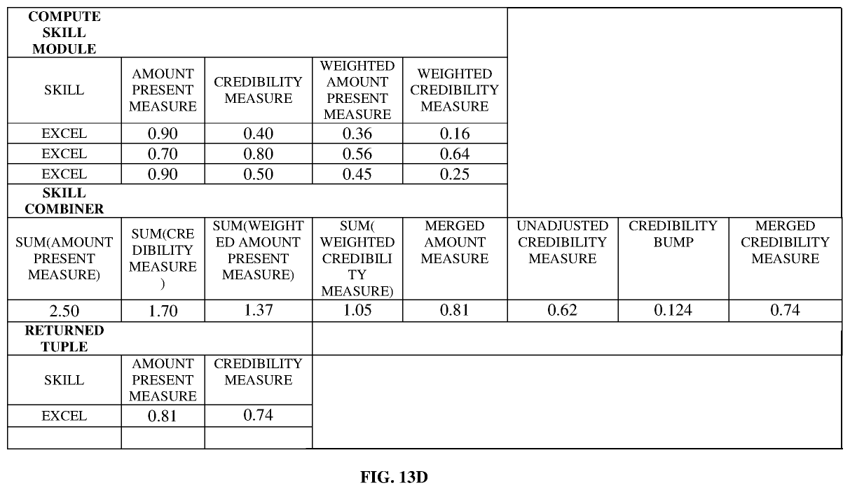

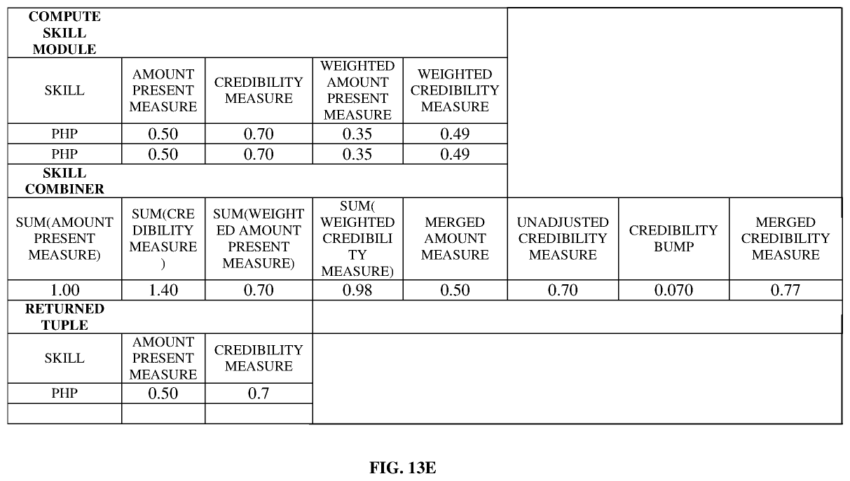

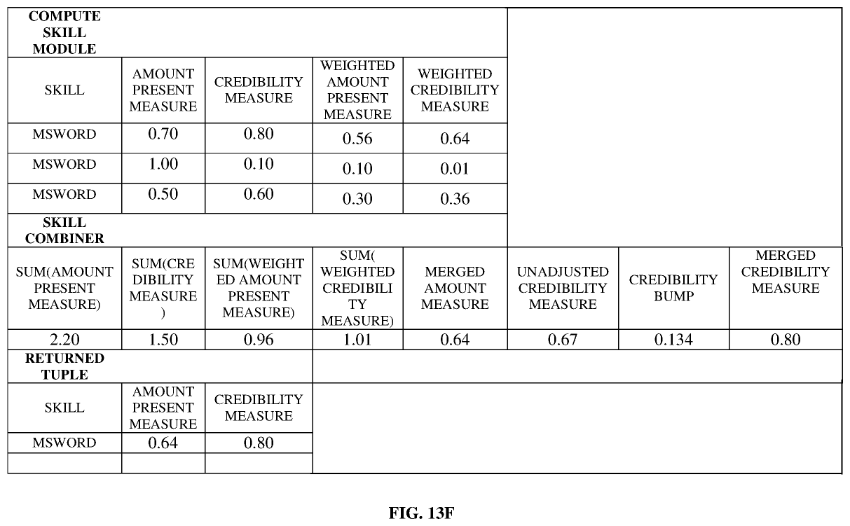

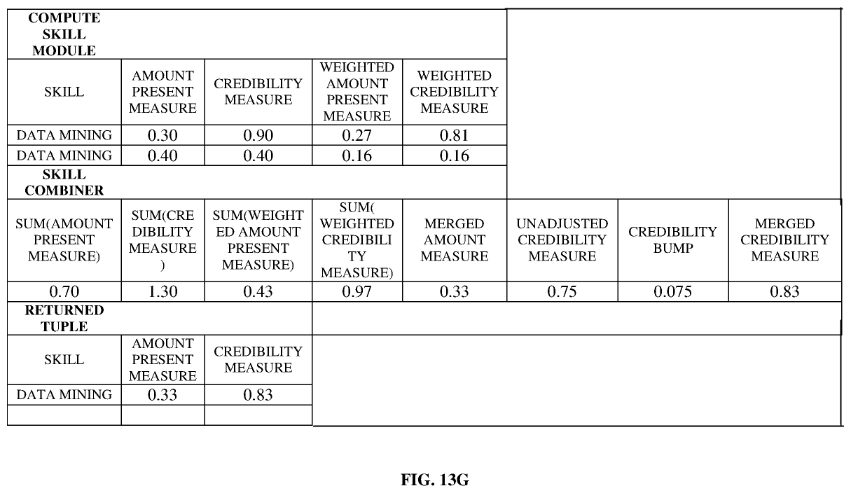

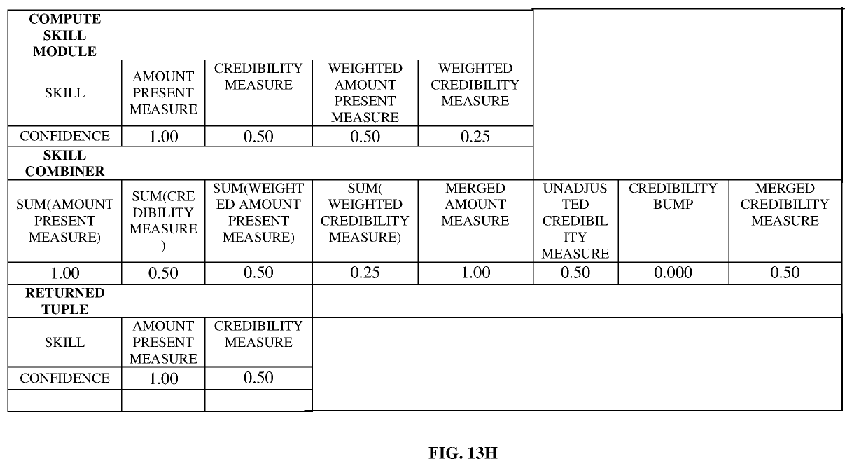

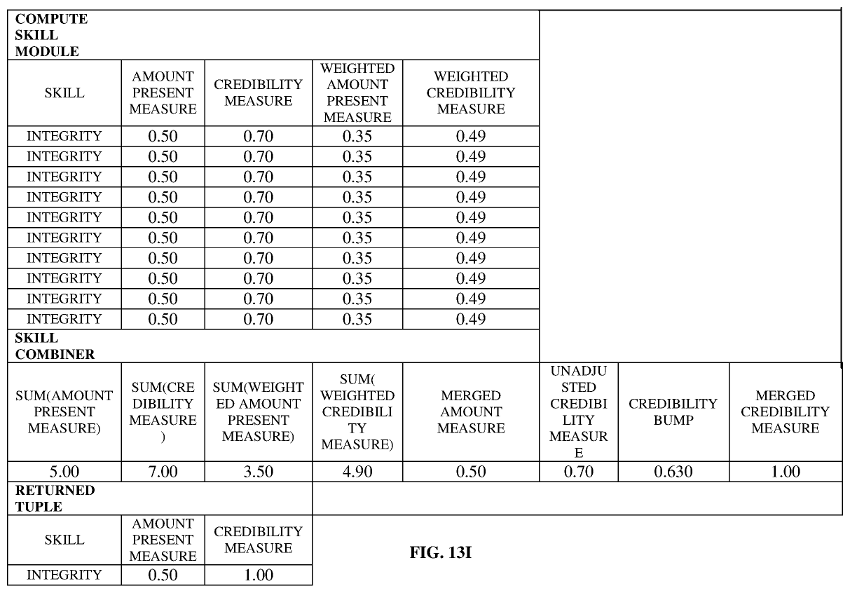

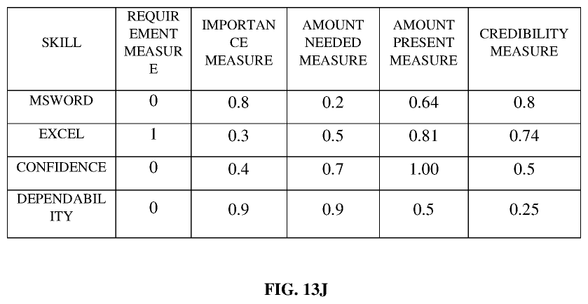

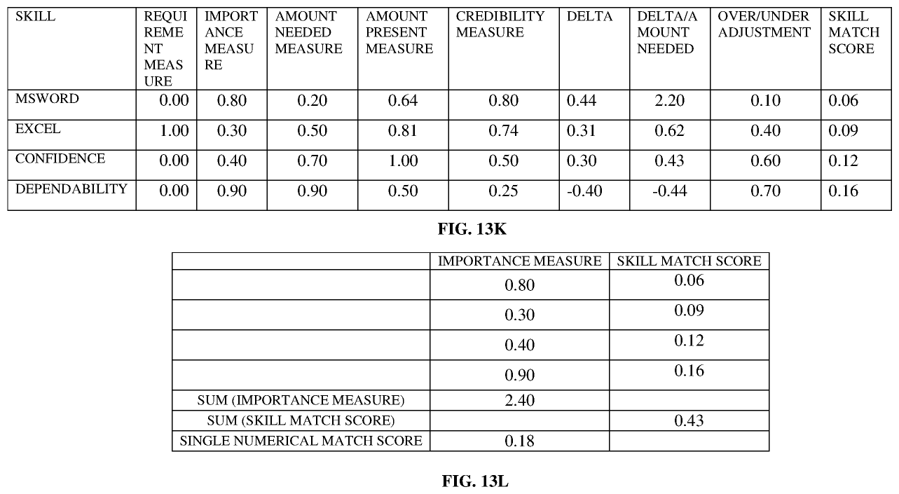

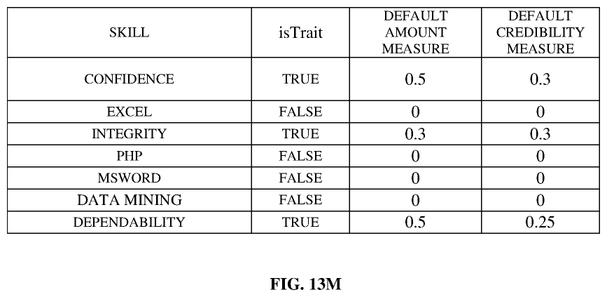

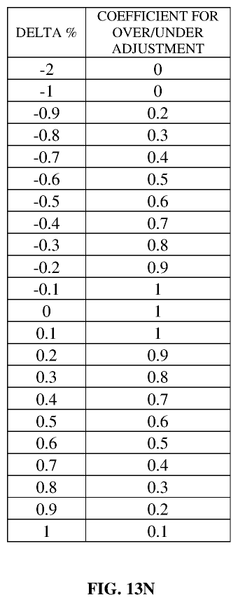

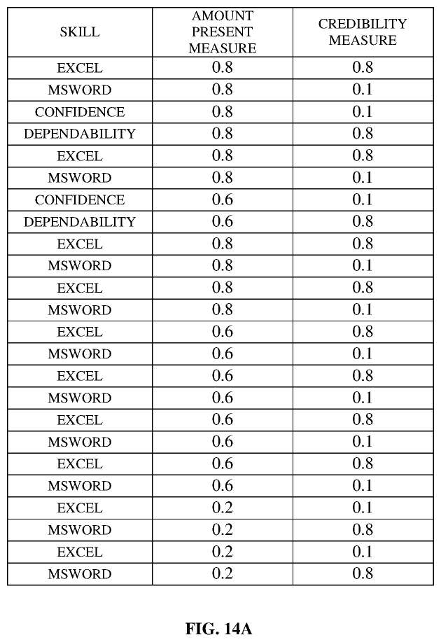

FIGS. 13A-13N exemplarily illustrate an embodiment of tabular representations of computations associated with opportunity seeker skills and opportunity description skills for determining a degree of match between opportunity seeker profiles with the opportunity seeker skills of varying credibility and opportunity descriptions with the opportunity description skills of varying importance. FIG. 13A exemplarily illustrates a first skill list comprising opportunity seeker skills, for example, MS Word, Excel, confidence, data mining, integrity, hypertext preprocessor (PHP) programming language, etc., extracted from job profiles, for example, resumes and reviews of the opportunity seekers. The first skill list comprises multiple occurrences of the opportunity seeker skills in random with corresponding skill amount measures and corresponding credibility measures. The first skill list is similar to that of the first skill list as exemplarily illustrated in the detailed description of FIG. 12A. As exemplarily illustrated in FIG. 13A, a first tuple in the first skill list comprises an opportunity seeker skill, for example, INTEGRITY, the opportunity seeker skill amount measure, that is, an amount present measure of 0.50, and a credibility measure of 0.70. Another first tuple in the first skill list comprises DATA MINING as an opportunity seeker skill with a corresponding amount present measure of 0.40 and a corresponding credibility measure of 0.40.

FIG. 13B exemplarily illustrates a second skill list comprising opportunity description skills required for an opportunity. The second skill list comprises second tuples and each of the second tuples comprises an opportunity description skill, an opportunity description skill amount measure corresponding to the opportunity description skill, a requirement measure, and an importance measure associated with the opportunity description skill. The second skill list is similar to that of the second skill list as exemplarily illustrated in the detailed description of FIG. 12B. As exemplarily illustrated in FIG. 13B, a second tuple in the second skill list comprises an opportunity description skill, for example, CONFIDENCE, a requirement measurement, that is, ISREQ value of NULL, an importance measure of 0.40, and an opportunity description skill amount measure, that is, an amount needed measure of 0.70. Another second tuple comprises, for example, DEPENDABILITY as an opportunity description skill with a corresponding requirement measure of 0, an importance measure of 0.90, and an amount needed measure of 0.90.

FIG. 13C exemplarily illustrates a unique skill list created from the first skill list exemplarily illustrated in FIG. 13A, by the opportunity matching system 200. As exemplarily illustrated in FIG. 13C, the unique skill list created from the first skill list, for example, EXCEL, the opportunity seeker skill amount measure, that is, an amount present measure of 0.81 and a credibility measure of 0.74. Another example of the unique skill list created from the first skill list, for PHP, the opportunity seeker skill amount measure, that is, an amount present measure of 0.50 and a credibility measure of 0.77.

The opportunity matching system 200 performs merging actions, that is, splitting and sorting of the first tuples of the first skill list and computes a merged skill amount measure, that is, the merged amount measure, and a merged credibility measure as exemplarily illustrated in FIGS. 13D-13I. FIGS. 13D-13I exemplarily illustrate 6 sub-lists of the opportunity seeker skills that are in the first skill list exemplarily illustrated in FIG. 13A. As exemplarily illustrated in FIG. 13D, the merging module 201 of the opportunity matching system 200 exemplarily illustrated in FIG. 2, creates a sub-list of the opportunity seeker skill, EXCEL, with a corresponding amount present measure, that is, the opportunity seeker skill amount measure of 0.90, 0.70, and 0.90 and the corresponding credibility measures of 0.40, 0.80, and 0.50 as exemplarily illustrated in FIG. 13D. The compute skill values module 210 exemplarily illustrated in FIG. 4, determines a weighted amount present measure, that is, a weighted skill amount measure as skill amount measure*credibility measure and a weighted credibility measure as credibility measure*credibility measure for each of the occurrences of the opportunity seeker skill, EXCEL, in the sub-list. The weighted amount present measure is computed as 0.36, 0.56, and 0.45 and the weighted credibility measure is computed as 0.16, 0.64, and 0.25 respectively for the 3 occurrences of the opportunity seeker skill, EXCEL, in the sublist. The skill combiner 212 exemplarily illustrated in FIG. 4, computes a merged amount measure, that is, a merged skill amount measure as Sum(weighted amount present measure)/Sum(credibility measure). Since there are three occurrences of the opportunity seeker skill EXCEL in the sub-list, the Sum(weighted amount present measure)=1.37, the Sum(credibility measure)=1.70, and the Sum(weighted credibility measure)=1.05. The skill combiner 212 computes the merged skill amount measure as 1.37/1.70=0.810 and an unadjusted credibility measure as Sum(weighted credibility measure)/Sum(credibility measure)=1.05/1.70=0.62. The skill combiner 212 computes the credibility bump as (Count(weighted credibility measure)−1)*unadjusted credibility measure*coeff_credbump with the coeff_credbump as 0.1. The coeff_credbump defines the amount of credibility bump to provide to the N sub-lists. The coeff_credbump drives computations performed by the skill combiner 212, affecting degree of adjustment to be made to the credibility measure. The skill combiner 212 computes the credibility bump as (3−1)*0.62*0.1=0.124. The skill combiner 212 computes the merged credibility measure as (unadjusted credibility measure+credibility bump)=0.62+0.124=0.744˜0.74. The merged skill amount measure of 0.81 is different than 0.83 which is the simple average of the amount present measures.

Similarly, the merging module 201 of the opportunity matching system 200 exemplarily illustrated in FIG. 2, creates a sub-list of the opportunity seeker skill, PHP, with a corresponding amount present measures 0.50, and 0.50 and a corresponding credibility measures of 0.70, and 0.70 as exemplarily illustrated in FIG. 13E. The compute skill values module 210 determines a weighted amount present measure as skill amount measure*credibility measure and a weighted credibility measure as credibility measure*credibility measure for each of the occurrences of the opportunity seeker skill, PHP, in the sub-list. The weighted amount present measure is computed as 0.35, and 0.35 and the weighted credibility measure is computed as 0.49, and 0.49 respectively for the 2 occurrences of the opportunity seeker skill, PHP, in the sublist. The skill combiner 212 computes a merged skill amount measure as the Sum(weighted amount present measure)/Sum(credibility measure). The Sum(weighted amount present measure)=0.70, the Sum(credibility measure)=1.40, and the Sum(weighted credibility measure)=0.98. The skill combiner 212 computes the merged skill amount measure as 0.70/1.40=0.500 and the unadjusted credibility measure as the Sum(weighted credibility measure)/Sum(credibility measure)=0.98/1.40=0.70. The skill combiner 212 computes the credibility bump as (Count(weighted credibility measure)−1)*unadjusted credibility measure*coeff_credbump with the coeff_credbump as 0.1. The skill combiner 212 computes the credibility bump as (2−1)*0.70*0.1=0.070. The skill combiner 212 computes the merged credibility measure as (unadjusted credibility measure+credibility bump)=0.70+0.070=0.77.

Similarly, the merging module 201 of the opportunity matching system 200 exemplarily illustrated in FIG. 2, creates a sub-list of the opportunity seeker skill, MSWORD, with a corresponding amount present measures 0.70, 1.00, and 0.50 and a corresponding credibility measures of 0.80, 0.10, and 0.60 as exemplarily illustrated in FIG. 13F. The compute skill values module 210 determines a weighted amount present measure as skill amount measure*credibility measure and a weighted credibility measure as credibility measure*credibility measure for each of the occurrences of the opportunity seeker skill, MSWORD, in the sub-list. The weighted amount present measure is computed as 0.56, 0.10, and 0.30 and the weighted credibility measure is computed as 0.64, 0.01, and 0.36 respectively for the 3 occurrences of the opportunity seeker skill, MSWORD, in the sublist. The skill combiner 212 computes a merged skill amount measure as the Sum(weighted amount present measure)/Sum(credibility measure). The Sum(weighted amount present measure)=0.96, the Sum(credibility measure)=1.50, and the Sum(weighted credibility measure)=1.01. The skill combiner 212 computes the merged skill amount measure as 0.96/1.50=0.640 and the unadjusted credibility measure as the Sum(weighted credibility measure)/Sum(credibility measure)=1.01/1.50=0.67. The skill combiner 212 computes the credibility bump as (Count(weighted credibility measure)−1)*unadjusted credibility measure*coeff_credbump with the coeff_credbump as 0.1. The skill combiner 212 computes the credibility bump as (3−1)*0.67*0.1=0.134. The skill combiner 212 computes the merged credibility measure as (unadjusted credibility measure+credibility bump)=0.67+0.134=0.804˜0.80. The merged skill amount measure of 0.64 is different than 0.73 which is the simple average of the amount present measures.

Similarly, the merging module 201 of the opportunity matching system 200 exemplarily illustrated in FIG. 2, creates a sub-list of the opportunity seeker skill, DATA MINING, with a corresponding amount present measures 0.30, and 0.40 and a corresponding credibility measures of 0.90, and 0.40 as exemplarily illustrated in FIG. 13G. The compute skill values module 210 determines a weighted amount present measure as skill amount measure*credibility measure and a weighted credibility measure as credibility measure*credibility measure for each of the occurrences of the opportunity seeker skill, DATA MINING, in the sub-list. The weighted amount present measure is computed as 0.27, and 0.16 and the weighted credibility measure is computed as 0.81, and 0.16 respectively for the 2 occurrences of the opportunity seeker skill, DATA MINING, in the sublist. The skill combiner 212 computes a merged skill amount measure as the Sum(weighted amount present measure)/Sum(credibility measure). The Sum(weighted amount present measure)=0.43, the Sum(credibility measure)=1.30, and the Sum(weighted credibility measure)=0.97. The skill combiner 212 computes the merged skill amount measure as 0.43/1.30=0.330 and the unadjusted credibility measure as the Sum(weighted credibility measure)/Sum(credibility measure)=0.97/1.30=0.75. The skill combiner 212 computes the credibility bump as (Count(weighted credibility measure)−1)*unadjusted credibility measure*coeff_credbump with the coeff_credbump as 0.1. The skill combiner 212 computes the credibility bump as (2−1)*0.75*0.1=0.075. The skill combiner 212 computes the merged credibility measure as (unadjusted credibility measure+credibility bump)=0.75+0.075=0.825˜0.83. The merged skill amount measure of 0.33 is different than 0.35 which is the simple average of the amount present measures.

Similarly, the merging module 201 of the opportunity matching system 200 exemplarily illustrated in FIG. 2, creates a sub-list of the opportunity seeker skill, CONFIDENCE, with a corresponding amount present measures 1.00 and a corresponding credibility measures of 0.50 as exemplarily illustrated in FIG. 13H. The compute skill values module 210 determines a weighted amount present measure as skill amount measure*credibility measure and a weighted credibility measure as credibility measure*credibility measure for each of the occurrences of the opportunity seeker skill, CONFIDENCE, in the sub-list. The weighted amount present measure is computed as 0.50 and the weighted credibility measure is computed as 0.25 respectively for only one occurrence of the opportunity seeker skill, CONFIDENCE, in the sublist. The skill combiner 212 computes a merged skill amount measure as the Sum(weighted amount present measure)/Sum(credibility measure). The Sum(weighted amount present measure)=0.50, the Sum(credibility measure)=0.50, and the Sum(weighted credibility measure)=0.25. The skill combiner 212 computes the merged skill amount measure as 0.50/0.50=1.000 and the unadjusted credibility measure as the Sum(weighted credibility measure)/Sum(credibility measure)=0.25/0.50=0.50. The skill combiner 212 computes the credibility bump as (Count(weighted credibility measure)−1)*unadjusted credibility measure*coeff_credbump with the coeff_credbump as 0.1. The skill combiner 212 computes the credibility bump as (1−1)*0.50*0.1=0.000. The skill combiner 212 computes the merged credibility measure as (unadjusted credibility measure+credibility bump)=0.50+0.000=0.50.

Similarly, the merging module 201 of the opportunity matching system 200 exemplarily illustrated in FIG. 2, creates a sub-list of the opportunity seeker skill, INTEGRITY, with a corresponding amount present measures 0.50, 0.50, 0.50, 0.50, 0.50, 0.50, 0.50, 0.50, 0.50, and 0.50 and a corresponding credibility measures of 0.70, 0.70, 0.70, 0.70, 0.70, 0.70, 0.70, 0.70, 0.70, and 0.70 as exemplarily illustrated in FIG. 13I. The compute skill values module 210 determines a weighted amount present measure as skill amount measure*credibility measure and a weighted credibility measure as credibility measure*credibility measure for each of the occurrences of the opportunity seeker skill, INTEGRITY, in the sub-list. The weighted amount present measure is computed as 0.35, 0.35, 0.35, 0.35, 0.35, 0.35, 0.35, 0.35, 0.35, and 0.35 and the weighted credibility measure is computed as 0.49, 0.49, 0.49, 0.49, 0.49, 0.49, 0.49, 0.49, 0.49, and 0.49 respectively for the 10 occurrences of the opportunity seeker skill, INTEGRITY, in the sublist. The skill combiner 212 computes a merged skill amount measure as the Sum(weighted amount present measure)/Sum(credibility measure). The Sum(weighted amount present measure)=3.50, the Sum(credibility measure)=7.00, and the Sum(weighted credibility measure)=4.90. The skill combiner 212 computes the merged skill amount measure as 3.50/7.00=0.500 and the unadjusted credibility measure as the Sum(weighted credibility measure)/Sum(credibility measure)=4.90/7.00=0.70. The skill combiner 212 computes the credibility bump as (Count(weighted credibility measure)−1)*unadjusted credibility measure*coeff_credbump with the coeff_credbump as 0.1. The skill combiner 212 computes the credibility bump as (10−1)*0.70*0.1=0.630. The skill combiner 212 computes the merged credibility measure as (unadjusted credibility measure+credibility bump)=0.70+0.630=1.33. The merged credibility measure is adjusted to have a maximum value of 1.

FIG. 13J exemplarily illustrates a matched skill list created by the opportunity matching system 200 by matching the unique opportunity seeker skills in the unique skill list exemplarily illustrated in FIG. 13C, with the opportunity description skills in the second skill list exemplarily illustrated in FIG. 13B. The opportunity description skill, DEPENDABILITY, in the second skill list exemplarily illustrated in FIG. 13B, is absent in the unique skill list exemplarily illustrated in FIG. 13C. The skill entry matching module 221 creates a skill present entry with the amount present measure and the credibility measure as 0.64 and 0.8 respectively for MSWORD, from the predefined skill table 224, that is, the skill list database exemplarily illustrated in FIG. 13M Similarly, the corresponding amount present measure and the corresponding credibility measure for EXCEL are 0.81 and 0.74 respectively as exemplarily illustrated in FIG. 13J.

FIG. 13K exemplarily illustrates the matched skill list exemplarily illustrated in FIG. 13J, comprising skill match scores generated by the score generation module 203 of the opportunity matching system 200 exemplarily illustrated in FIG. 2, on matching the unique opportunity seeker skills in the unique skill list exemplarily illustrated in FIG. 13C, with the opportunity description skills in the second skill list exemplarily illustrated in FIG. 13B. The match score generation module 228, exemplarily illustrated in FIG. 9, computes delta as difference in a skill amount present measure and a skill amount needed measure. As exemplarily illustrated in FIG. 13K, the delta for the matched skill, MSWORD, is 0.64−0.20=0.44. The match score generation module 228 determines an over/under adjustment using a lookup of (delta/skill amount needed measure) against the amount measure deviation lookup table exemplarily illustrated in FIG. 13N. The value of (delta/skill amount needed measure)=0.44/0.20=2.20. The corresponding over/under adjustment from the amount measure deviation lookup table is 0.10. The match score generation module 228 computes the skill match score as (importance measure*credibility measure*over/under adjustment)=0.80*0.80*0.10=0.064˜0.06 as exemplarily illustrated in FIG. 13K. Similarly, for the other matched skills, the match score generation module 228 computes the skill match scores as 0.09, 0.12, and 0.16 for the matched skills EXCEL, CONFIDENCE, and DEPENDABILITY respectively.

FIG. 13L exemplarily illustrates a tabular representation for generation of an opportunity match score defining the degree of match between the opportunity seeker profiles and the opportunity descriptions by the final score generation module 231 exemplarily illustrated in FIG. 9. The final score generation module 231 calculates a single numerical match score, that is, the opportunity match score, as the Sum(skill match score)/Sum(importance measure)=(0.06+0.09+0.12+0.16)/(0.80+0.30+0.40+0.90)=0.43/2.40=0.1796˜0.18. The single numerical match score of 0.180 is different than 0.108 which is the simple average of the skill match score without using importance as a weight.

FIG. 13M exemplarily illustrates a tabular representation of the default amount pressure and the default credibility measure. For example, the opportunity seeker skill of CONFIDENCE, if the isTrait representation is TRUE, the default amount measure is 0.5 and the corresponding credibility measure is 0.3. The opportunity seeker skill of PHP, if the isTrait representation is FALSE, the default amount measure and the corresponding credibility measure are 0.

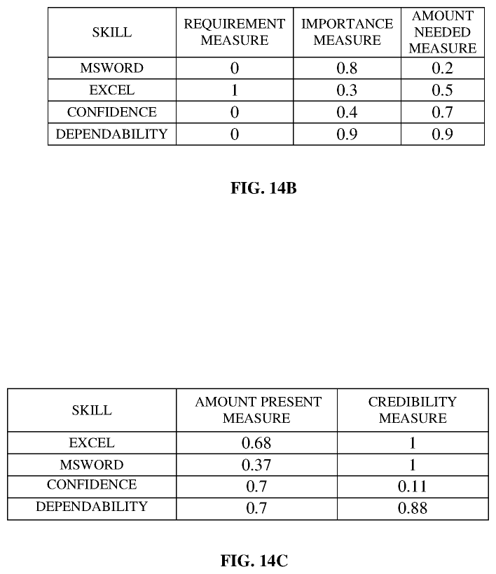

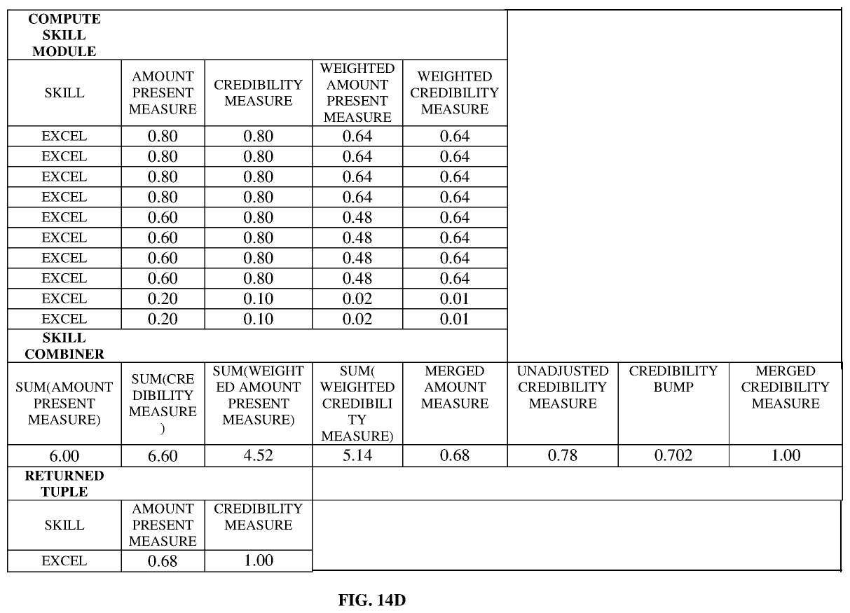

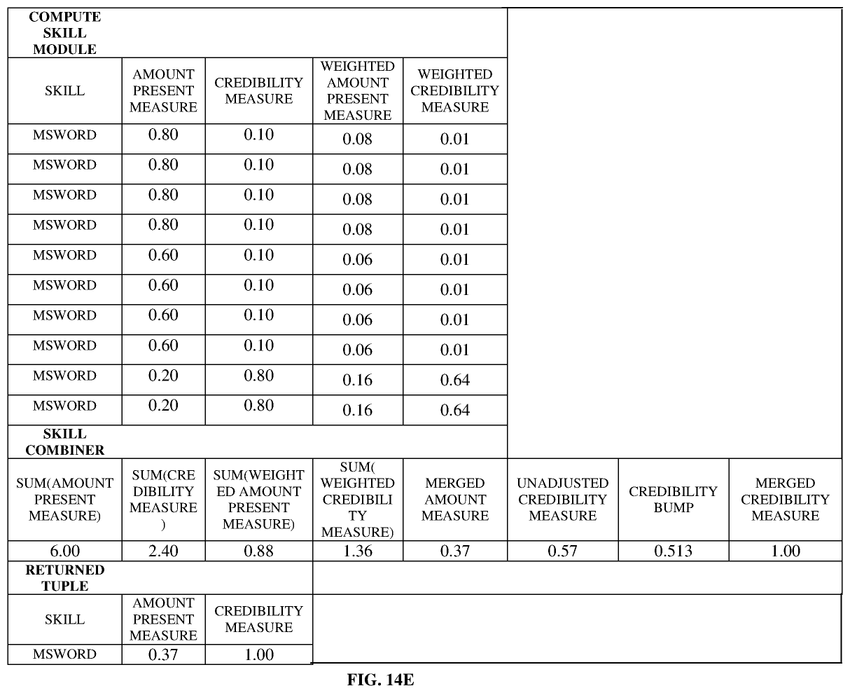

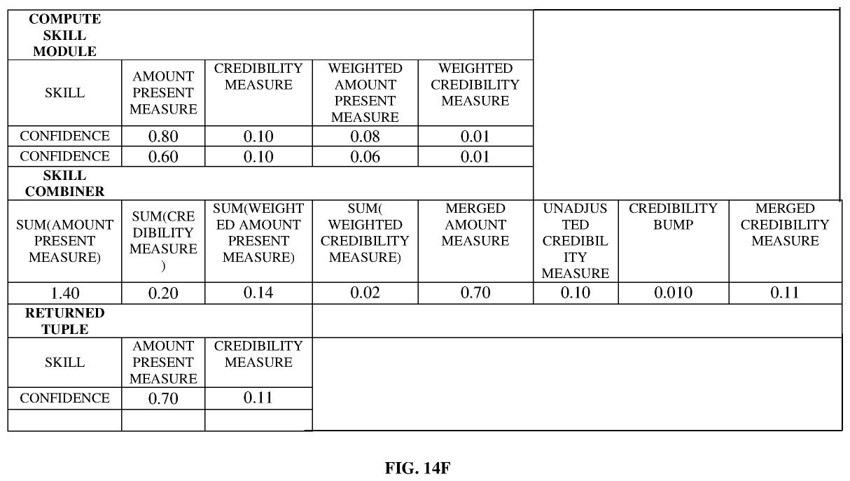

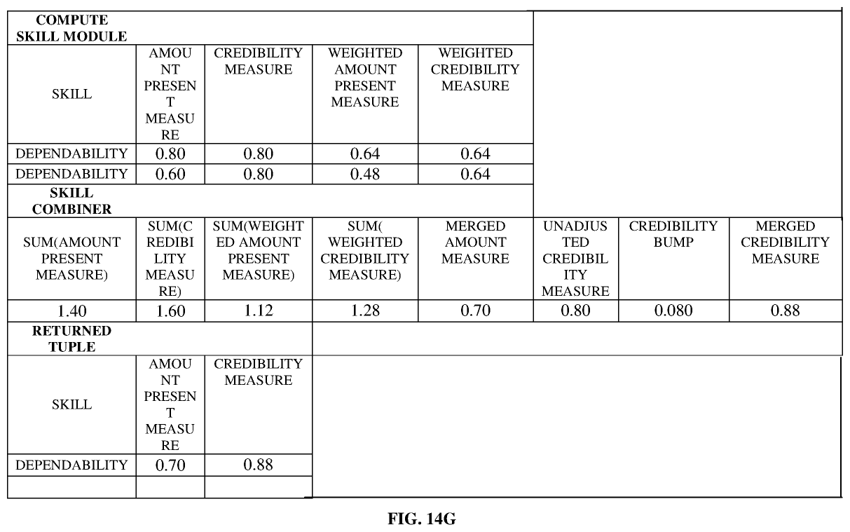

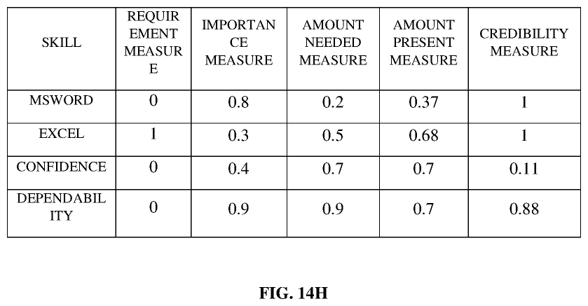

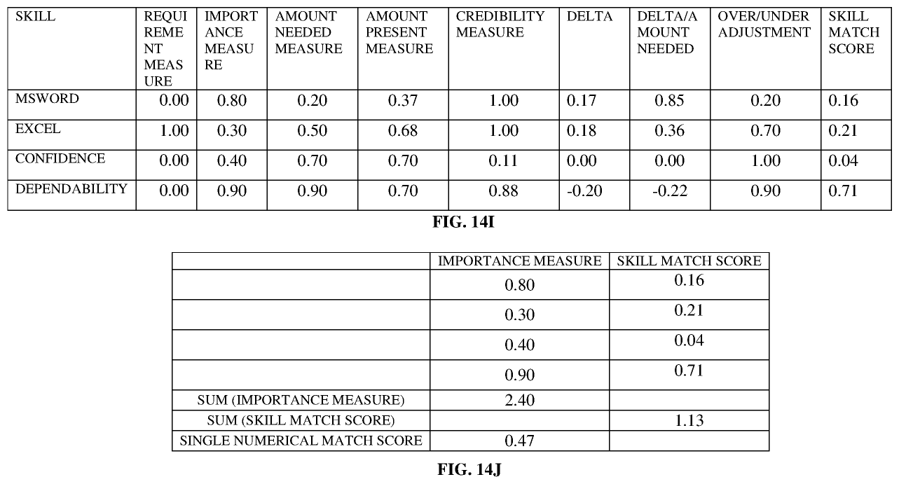

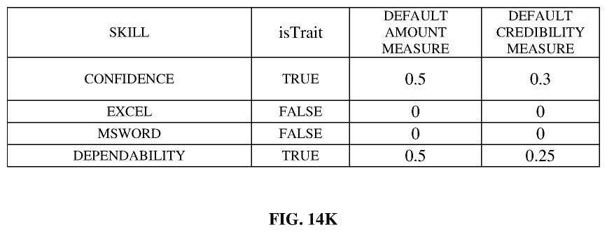

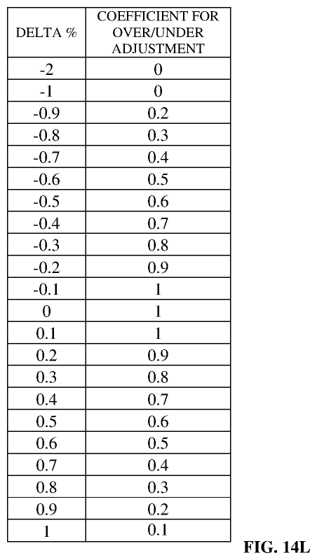

FIGS. 14A-14N exemplarily illustrate another embodiment of tabular representations of computations associated with opportunity seeker skills and opportunity description skills for determining a degree of match between opportunity seeker profiles with the opportunity seeker skills of varying credibility and opportunity descriptions with the opportunity description skills of varying importance. FIG. 14A exemplarily illustrates a first skill list comprising opportunity seeker skills, for example, MS Word, Excel, confidence, data mining, integrity, hypertext preprocessor (PHP) programming language, etc., extracted from job profiles, for example, resumes and reviews of the opportunity seekers. As exemplarily illustrated in FIG. 14A, the first skill list comprises multiple occurrences of the opportunity seeker skills in random with corresponding skill amount measures and corresponding credibility measures. The opportunity matching system 200 receives the first skill list exemplarily illustrated in FIG. 12A, FIG. 13A, and FIG. 14A comprising the opportunity seeker skills from a skill list database. The first skill list comprises first tuples and each of the first tuples comprises an opportunity seeker skill, an opportunity seeker skill amount measure corresponding to the opportunity seeker skill, and a credibility measure indicating credibility of the opportunity seeker skill amount measure as exemplarily illustrated in the detailed description of FIG. 12A, FIG. 13A, and FIG. 14A. As exemplarily illustrated in FIG. 14A, a first tuple in the first skill list comprises an opportunity seeker skill, for example, EXCEL, the opportunity seeker skill amount measure, that is, an amount present measure of 0.8, and a credibility measure of 0.8. Another first tuple in the first skill list comprises MSWORD as an opportunity seeker skill with a corresponding amount present measure of 0.8 and a corresponding credibility measure of 0.1.

FIG. 14B exemplarily illustrates a second skill list comprising opportunity description skills required for an opportunity. The second skill list comprises second tuples and each of the second tuples comprises an opportunity description skill, an opportunity description skill amount measure corresponding to the opportunity description skill, a requirement measure, and an importance measure associated with the opportunity description skill. The second skill list is similar to that of the second skill list as exemplarily illustrated in the detailed description of FIG. 12B and FIG. 13B. As exemplarily illustrated in FIG. 14B, a second tuple in the second skill list comprises an opportunity description skill, for example, MSWORD, a requirement measurement, that is, ISREQ value of NULL, an importance measure of 0.8, and an opportunity description skill amount measure, that is, an amount needed measure of 0.20. Another second tuple comprises, for example, EXCEL as an opportunity description skill with a corresponding requirement measure of 1, an importance measure of 0.30, and an amount needed measure of 0.50. The opportunity matching system 200 receives the second skill list exemplarily illustrated in FIG. 12B, FIG. 13B, and FIG. 14B from the skill list database.

FIG. 14C exemplarily illustrates a unique skill list created from the first skill list exemplarily illustrated in FIG. 14A, by the opportunity matching system 200. As exemplarily illustrated in FIG. 14C, the unique skill list created from the first skill list, for example, EXCEL, the opportunity seeker skill amount measure, that is, an amount present measure of 0.68 and a credibility measure of 1. Another example of the unique skill list created from the first skill list, for MSWORD, the opportunity seeker skill amount measure, that is, an amount present measure of 0.37 and a credibility measure of 1.

The opportunity matching system 200 performs merging actions, that is, splitting and sorting of the first tuples of the first skill list and computes a merged skill amount measure, that is, the merged amount measure, and a merged credibility measure as exemplarily illustrated in FIGS. 14D-14G. FIGS. 14D-14G exemplarily illustrate 4 sub-lists of the opportunity seeker skills that are in the first skill list exemplarily illustrated in FIG. 14A. As exemplarily illustrated in FIG. 14D, the merging module 201 of the opportunity matching system 200 exemplarily illustrated in FIG. 2, creates a sub-list of the opportunity seeker skill, EXCEL, with a corresponding amount present measures 0.80, 0.80, 0.80, 0.80, 0.60, 0.60, 0.60, 0.60, 0.20, and 0.20 and a corresponding credibility measures of 0.80, 0.80, 0.80, 0.80, 0.80, 0.80, 0.80, 0.80, 0.10, and 0.10 as exemplarily illustrated in FIG. 14D. The compute skill values module 210 determines a weighted amount present measure as skill amount measure*credibility measure and a weighted credibility measure as credibility measure*credibility measure for each of the occurrences of the opportunity seeker skill, EXCEL, in the sub-list. The weighted amount present measure is computed as 0.64, 0.64, 0.64, 0.64, 0.48, 0.48, 0.48, 0.48, 0.02, and 0.02 and the weighted credibility measure is computed as 0.64, 0.64, 0.64, 0.64, 0.64, 0.64, 0.64, 0.64, 0.01, and 0.01 respectively for the 10 occurrences of the opportunity seeker skill, EXCEL, in the sublist. The skill combiner 212 computes a merged skill amount measure as the Sum(weighted amount present measure)/Sum(credibility measure). The Sum(weighted amount present measure)=4.52, the Sum(credibility measure)=6.60, and the Sum(weighted credibility measure)=5.14. The skill combiner 212 computes the merged skill amount measure as 4.52/6.60=0.680 and the unadjusted credibility measure as the Sum(weighted credibility measure)/Sum(credibility measure)=5.14/6.60=0.78. The skill combiner 212 computes the credibility bump as (Count(weighted credibility measure)−1)*unadjusted credibility measure*coeff_credbump with the coeff_credbump as 0.1. The coeff_credbump defines the amount of credibility bump to provide to the N sub-lists. The coeff_credbump drives computations performed by the skill combiner 212, affecting degree of adjustment to be made to the credibility measure. The skill combiner 212 computes the credibility bump as (10−1)*0.78*0.1=0.702. The skill combiner 212 computes the merged credibility measure as (unadjusted credibility measure+credibility bump)=0.78+0.702=1.482˜148. The merged credibility measure is adjusted to have a maximum value of 1. The merged skill amount measure of 0.68 is different than 0.60 which is the simple average of the amount present measures.

Similarly, the merging module 201 of the opportunity matching system 200 exemplarily illustrated in FIG. 2, creates a sub-list of the opportunity seeker skill, MSWORD, with a corresponding amount present measures 0.80, 0.80, 0.80, 0.80, 0.60, 0.60, 0.60, 0.60, 0.20, and 0.20 and a corresponding credibility measures of 0.10, 0.10, 0.10, 0.10, 0.10, 0.10, 0.10, 0.10, 0.80, and 0.80 as exemplarily illustrated in FIG. 14E. The compute skill values module 210 determines a weighted amount present measure as skill amount measure*credibility measure and a weighted credibility measure as credibility measure*credibility measure for each of the occurrences of the opportunity seeker skill, MSWORD, in the sub-list. The weighted amount present measure is computed as 0.08, 0.08, 0.08, 0.08, 0.06, 0.06, 0.06, 0.06, 0.16, and 0.16 and the weighted credibility measure is computed as 0.01, 0.01, 0.01, 0.01, 0.01, 0.01, 0.01, 0.01, 0.64, and 0.64 respectively for the 10 occurrences of the opportunity seeker skill, MSWORD, in the sublist. The skill combiner 212 computes a merged skill amount measure as the Sum(weighted amount present measure)/Sum(credibility measure). The Sum(weighted amount present measure)=0.88, the Sum(credibility measure)=2.40, and the Sum(weighted credibility measure)=1.36. The skill combiner 212 computes the merged skill amount measure as 0.88/2.40=0.370 and the unadjusted credibility measure as the Sum(weighted credibility measure)/Sum(credibility measure)=1.36/2.40=0.57. The skill combiner 212 computes the credibility bump as (Count(weighted credibility measure)−1)*unadjusted credibility measure*coeff_credbump with the coeff_credbump as 0.1. The skill combiner 212 computes the credibility bump as (10−1)*0.57*0.1=0.513. The skill combiner 212 computes the merged credibility measure as (unadjusted credibility measure+credibility bump)=0.57+0.513=1.083˜1.08. The merged credibility measure is adjusted to have a maximum value of 1. The merged skill amount measure of 0.37 is different than 0.60 which is the simple average of the amount present measures.

Similarly, the merging module 201 of the opportunity matching system 200 exemplarily illustrated in FIG. 2, creates a sub-list of the opportunity seeker skill, CONFIDENCE, with a corresponding amount present measures 0.80, and 0.60 and a corresponding credibility measures of 0.10, and 0.10 as exemplarily illustrated in FIG. 14F. The compute skill values module 210 determines a weighted amount present measure as skill amount measure*credibility measure and a weighted credibility measure as credibility measure*credibility measure for each of the occurrences of the opportunity seeker skill, CONFIDENCE, in the sub-list. The weighted amount present measure is computed as 0.08, and 0.06 and the weighted credibility measure is computed as 0.01, and 0.01 respectively for the 2 occurrences of the opportunity seeker skill, CONFIDENCE, in the sublist. The skill combiner 212 computes a merged skill amount measure as the Sum(weighted amount present measure)/Sum(credibility measure). The Sum(weighted amount present measure)=0.14, the Sum(credibility measure)=0.20, and the Sum(weighted credibility measure)=0.02. The skill combiner 212 computes the merged skill amount measure as 0.14/0.20=0.700 and the unadjusted credibility measure as the Sum(weighted credibility measure)/Sum(credibility measure)=0.02/0.20=0.10. The skill combiner 212 computes the credibility bump as (Count(weighted credibility measure)−1)*unadjusted credibility measure*coeff_credbump with the coeff_credbump as 0.1. The skill combiner 212 computes the credibility bump as (2−1)*0.10*0.1=0.010. The skill combiner 212 computes the merged credibility measure as (unadjusted credibility measure+credibility bump)=0.10+0.010=0.11.

Similarly, the merging module 201 of the opportunity matching system 200 exemplarily illustrated in FIG. 2, creates a sub-list of the opportunity seeker skill, DEPENDABILITY, with the corresponding amount present measures 0.80, and 0.60 and the corresponding credibility measures of 0.80, and 0.80 as exemplarily illustrated in FIG. 14G. The compute skill values module 210 determines a weighted amount present measure as skill amount measure*credibility measure and a weighted credibility measure as credibility measure*credibility measure for each of the occurrences of the opportunity seeker skill, DEPENDABILITY, in the sub-list. The weighted amount present measure is computed as 0.64, and 0.48 and the weighted credibility measure is computed as 0.64, and 0.64 respectively for the 2 occurrences of the opportunity seeker skill, DEPENDABILITY, in the sublist. The skill combiner 212 computes a merged skill amount measure as the Sum(weighted amount present measure)/Sum(credibility measure). The Sum(weighted amount present measure)=1.12, the Sum(credibility measure)=1.60, and the Sum(weighted credibility measure)=1.28. The skill combiner 212 computes the merged skill amount measure as 1.12/1.60=0.700 and the unadjusted credibility measure as the Sum(weighted credibility measure)/Sum(credibility measure)=1.28/1.60=0.80. The skill combiner 212 computes the credibility bump as (Count(weighted credibility measure)−1)*unadjusted credibility measure*coeff_credbump with the coeff_credbump as 0.1. The skill combiner 212 computes the credibility bump as (2−1)*0.80*0.1=0.080. The skill combiner 212 computes the merged credibility measure as (unadjusted credibility measure+credibility bump)=0.80+0.080=0.88.

FIG. 14H exemplarily illustrates a matched skill list created by the opportunity matching system 200 by matching the unique opportunity seeker skills in the unique skill list exemplarily illustrated in FIG. 14C, with the opportunity description skills in the second skill list exemplarily illustrated in FIG. 14B. The skill entry matching module 221 creates a skill present entry with the amount present measure and the credibility measure as 0.37 and 1 respectively for MSWORD, from the predefined skill table 224, that is, the skill list database exemplarily illustrated in FIG. 14K. Similarly, the corresponding amount present measure and the corresponding credibility measure for EXCEL are 0.68 and 1 respectively as exemplarily illustrated in FIG. 14H.

FIG. 14I exemplarily illustrates the matched skill list exemplarily illustrated in FIG. 14H, comprising skill match scores generated by the score generation module 203 of the opportunity matching system 200 exemplarily illustrated in FIG. 2, on matching the unique opportunity seeker skills in the unique skill list exemplarily illustrated in FIG. 14C, with the opportunity description skills in the second skill list exemplarily illustrated in FIG. 14B. The match score generation module 228, exemplarily illustrated in FIG. 9, computes delta as difference in a skill amount present measure and a skill amount needed measure. As exemplarily illustrated in FIG. 14I, the delta for the matched skill, MSWORD, is 0.37−0.20=0.17. The match score generation module 228 determines an over/under adjustment using a lookup of (delta/skill amount needed measure) against the amount measure deviation lookup table exemplarily illustrated in FIG. 14L. The value of (delta/skill amount needed measure)=0.17/0.20=0.85. The corresponding over/under adjustment from the amount measure deviation lookup table is 0.20. The match score generation module 228 computes the skill match score as (importance measure*credibility measure*over/under adjustment)=0.80*1.00*0.20=0.16 as exemplarily illustrated in FIG. 14I. Similarly, for the other matched skills, the match score generation module 228 computes the skill match scores as 0.21, 0.04, and 0.71 for the matched skills EXCEL, CONFIDENCE, and DEPENDABILITY respectively.

FIG. 14J exemplarily illustrates a tabular representation for generation of an opportunity match score defining the degree of match between the opportunity seeker profiles and the opportunity descriptions by the final score generation module 231 exemplarily illustrated in FIG. 9. The final score generation module 231 calculates a single numerical match score, that is, the opportunity match score, as the Sum(skill match score)/Sum(importance measure)=(0.16+0.21+0.04+0.71)/(0.80+0.30+0.40+0.90)=1.13/2.40=0.4696˜0.47. The single numerical match score of 0.470 is different than 0.282 which is the simple average of the skill match score without using importance as a weight.

FIG. 14K exemplarily illustrates a tabular representation of the default amount pressure and the default credibility measure. For example, the opportunity seeker skill of CONFIDENCE, if the isTrait representation is TRUE, the default amount measure is 0.5 and the corresponding credibility measure is 0.3. The opportunity seeker skill of DEPENDABILITY, if the isTrait representation is TRUE, the default amount measure is 0.5 and the corresponding credibility measure is 0.25.

As exemplarily illustrated in the detailed description of FIGS. 14A-14L, for example, the opportunity matching system 200 identifies EXCEL with 10 ratings and 2 of which are outliers. The opportunity seeker skill with 8 ratings is considered to be of high credibility and the outliers are considered to be of low credibility. The amount present measure is 0.68 and is very close to the $ ratings. The low credibility outliers have minimum effect. In another example, the opportunity matching system 200 identifies SWORD with 10 ratings and 2 of which are outliers. The opportunity seeker skills with 8 ratings are considered to be of low credibility and the outliers are considered to be of high credibility. The amount present measure is 0.37 and is very close to the 2 high credibility outliers. In another example, the opportunity matching system 200 identifies DEPENABILITY with 2 high credibility ratings. The amount present measure is midway between the two with higher credibility than either of the 2 ratings. In another example, the opportunity matching system 200 identifies, CONFIDENCE with 2 low credibility ratings. The amount present measure is midway between the two and the same as for INTEGRITY, with higher credibility than either of the 2 ratings but much lower than that of INTEGRITY. The credibility of the individual ratings is based on the aggregated amount present measure. The outliers can be nearly ignored or very significant depending on their credibility. The credibility does not affect the amount present measure but affects the aggregated credibility which in turn affects the skill match score.

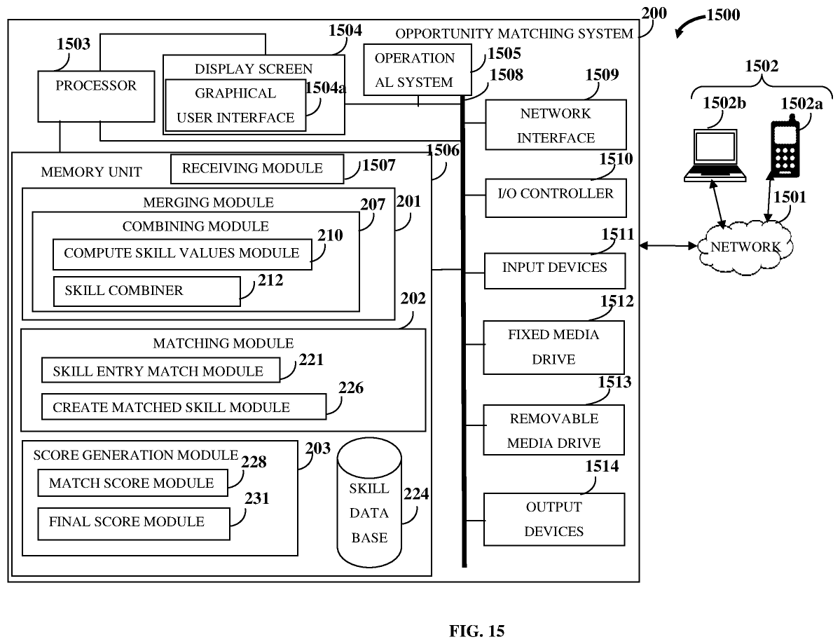

FIG. 15 exemplarily illustrates a computer implemented system 1500 comprising the opportunity matching system 200 for determining a degree of match between opportunity seeker profiles with opportunity seeker skills of varying credibility and opportunity descriptions with opportunity description skills of varying importance. The opportunity matching system 200 is a computer system that is programmable using a high level computer programming language. In an embodiment, the opportunity matching system 200 uses programmed and purposeful hardware. The opportunity matching system 200 is implemented on a computing device, for example, a personal computer, a tablet computing device, a mobile computer, a portable computing device, a laptop, a touch device, a workstation, a server, portable electronic device, a network enabled computing device, an interactive network enabled communication device, any other suitable computing equipment, combinations of multiple pieces of computing equipment, etc. In an embodiment, the computing equipment is used to implement applications such as media playback applications, a web browser, an electronic mail (email) application, a calendar application, etc. In another embodiment, the computing equipment, for example, one or more servers are associated with one or more online services. In an embodiment, the opportunity matching system 200 is configured as a web based platform, for example, a website hosted on a server or a network of servers.

The opportunity matching system 200 communicates with user devices 1502 via the network 1501, for example, a short range network or a long range network. The user devices 1502 comprising 1502a, 1502b, are electronic devices, for example, personal computers, tablet computing devices, mobile computers, mobile phones, smartphones, portable computing devices, personal digital assistants, laptops, wearable computing devices such as the Google Glass® of Google Inc., the Apple Watch® of Apple Inc., etc., touch centric devices, client devices, portable electronic devices, network enabled computing devices, interactive network enabled communication devices, any other suitable computing equipment, combinations of multiple pieces of computing equipment, etc. In an embodiment, the user devices 1502a and 1502b are hybrid computing devices that combine the functionality of multiple devices. Examples of a hybrid computing device comprise a cellular telephone that includes a media player functionality, a gaming device that includes a wireless communications capability, a cellular telephone that includes a document reader and multimedia functions, and a portable device that has network browsing, document rendering, and network communication capabilities. For purposes of illustration, the user device 1502a and 1502b are user devices of a recruitment system of entities such as offices, educational institutes, etc.

The network 1501 is, for example, the internet, an intranet, a wireless network, a communication network that implements Bluetooth® of Bluetooth Sig, Inc., a network that implements Wi-Fi® of Wi-Fi Alliance Corporation, an ultra-wideband communication network (UWB), a wireless universal serial bus (USB) communication network, a communication network that implements ZigBee® of ZigBee Alliance Corporation, a general packet radio service (GPRS) network, a mobile telecommunication network such as a global system for mobile (GSM) communications network, a code division multiple access (CDMA) network, a third generation (3G) mobile communication network, a fourth generation (4G) mobile communication network, a fifth generation (5G) mobile communication network, a long-term evolution (LTE) mobile communication network, a public telephone network, etc., a local area network, a wide area network, an internet connection network, an infrared communication network, etc., or a network formed from any combination of these networks. In an embodiment, the opportunity matching system 200 is accessible to the satellite internet of users, for example, through a broad spectrum of technologies and devices such as cellular phones, tablet computing devices, etc., with access to the internet.

As exemplarily illustrated in FIG. 15, the opportunity matching system 200 comprises a non-transitory computer readable storage medium, for example, a memory unit 1506 for storing programs and data, and at least one processor 1503 communicatively coupled to the non-transitory computer readable storage medium. As used herein, “non-transitory computer readable storage medium” refers to all computer readable media, for example, non-volatile media, volatile media, and transmission media, except for a transitory, propagating signal. Non-volatile media comprise, for example, solid state drives, optical discs or magnetic disks, and other persistent memory volatile media including a dynamic random access memory (DRAM), which typically constitute a main memory. Volatile media comprise, for example, a register memory, a processor cache, a random access memory (RAM), etc. Transmission media comprise, for example, coaxial cables, copper wire, fiber optic cables, modems, etc., including wires that constitute a system bus coupled to the processor 1503. The non-transitory computer readable storage medium is configured to store computer program instructions defined by modules, for example, 1507, 201, 202, 203, 207, 210, 212, 221, 226, 228, 231 etc., of the opportunity matching system 200. The modules 1507, 201, 202, 203, 207, 210, 212, 221, 226, 228, and 231 are installed and stored in the memory unit 1506 of the opportunity matching system 200. The memory unit 1506 is used for storing program instructions, applications, and data. The memory unit 1506 is, for example, a random access memory (RAM) or another type of dynamic storage device that stores information and instructions for execution by the processor 1503. The memory unit 1506 also stores temporary variables and other intermediate information used during execution of the instructions by the processor 1503. The opportunity matching system 200 further comprises a read only memory (ROM) or another type of static storage device that stores static information and instructions for the processor 1503.

The processor 1503 is configured to execute the computer program instructions defined by the modules, for example, 1507, 201, 202, 203, 207, 210, 212, 221, 226, 228, 231 etc., of the opportunity matching system 200. The processor 1503 refers to any of one or more microprocessors, central processing unit (CPU) devices, finite state machines, computers, microcontrollers, digital signal processors, logic, a logic device, an user circuit, an application specific integrated circuit (ASIC), a field-programmable gate array (FPGA), a chip, etc., or any combination thereof, capable of executing computer programs or a series of commands, instructions, or state transitions. In an embodiment, the processor 1503 is implemented as a processor set comprising, for example, a programmed microprocessor and a math or graphics co-processor. The processor 1503 is selected, for example, from the Intel® processors such as the Itanium® microprocessor or the Pentium® processors, Advanced Micro Devices (AMD®) processors such as the Athlon® processor, UltraSPARC® processors, microSPARC® processors, Hp® processors, International Business Machines (IBM®) processors such as the PowerPC® microprocessor, the MIPS® reduced instruction set computer (RISC) processor of MIPS Technologies, Inc., RISC based computer processors of ARM Holdings, Motorola® processors, Qualcomm® processors, etc. The opportunity matching system 200 disclosed herein is not limited to employing a processor 1503. In an embodiment, the opportunity matching system 200 employs a controller or a microcontroller.

As exemplarily illustrated in FIG. 15, the opportunity matching system 200 further comprises a data bus 1508, a network interface 1509, an input/output (I/O) controller 1510, input devices 1511, a fixed media drive 1512 such as a hard drive, a removable media drive 1513 for receiving removable media, output devices 1514, etc. The data bus 1508 permits communications between the modules, for example, 1507, 201, 202, 203, 207, 210, 212, 221, 226, 228, 231 etc., of the opportunity matching system 200. The network interface 1509 enables connection of the opportunity matching system 200 to the network 1501. In an embodiment, the network interface 1509 is provided as an interface card also referred to as a line card. The network interface 1509 comprises, for example, one or more of an infrared (IR) interface, an interface implementing Wi-Fi® of Wi-Fi Alliance Corporation, a universal serial bus (USB) interface, a FireWire® interface of Apple Inc., an Ethernet interface, a frame relay interface, a cable interface, a digital subscriber line (DSL) interface, a token ring interface, a peripheral controller interconnect (PCI) interface, a local area network (LAN) interface, a wide area network (WAN) interface, interfaces using serial protocols, interfaces using parallel protocols, Ethernet communication interfaces, asynchronous transfer mode (ATM) interfaces, a high speed serial interface (HSSI), a fiber distributed data interface (FDDI), interfaces based on a transmission control protocol (TCP)/internet protocol (IP), interfaces based on wireless communications technology such as satellite technology, radio frequency (RF) technology, near field communication, etc. The I/O controller 1510 controls input actions and output actions performed by the opportunity matching system 200.

The display screen 1504, via the graphical user interface (GUI) 1504a, displays opportunity seeker skills and the opportunity description skills. The display screen 1504 is, for example, a video display, a liquid crystal display, a plasma display, an organic light emitting diode (OLED) based display, etc. The opportunity matching system 200 provides the GUI 1504a on the display screen 1504. The GUI 1504a is, for example, an online web interface, a web based downloadable application interface, a mobile based downloadable application interface, etc. The display screen 1504 displays the GUI 1504a. The input devices 1511 are used for inputting data into the opportunity matching system 200. The input devices 1511 are, for example, a keyboard such as an alphanumeric keyboard, a microphone, a joystick, a pointing device such as a computer mouse, a touch pad, a light pen, a physical button, a touch sensitive display device, a track ball, a pointing stick, any device capable of sensing a tactile input, etc. The output devices 1514 output the results of operations performed by the opportunity matching system 200.

The modules of the opportunity matching system 200 comprise a receiving module 1507, a merging module 201, a matching module 202, and a score generation module 203 stored in the memory unit 1506 of the opportunity matching system 200. The receiving module 1507 receives a first skill list comprising the opportunity seeker skills in the opportunity seeker profiles and a second skill list comprising the opportunity description skills required for an opportunity from a skill list database 224. The merging module 201 performs merging actions on the opportunity seeker skills in the first skill list and returns a list of unique merged skills present. The merging module 201 further combines multiple occurrences of the opportunity seeker skills in the list of skills present into one entry per opportunity seeker skill in the list of unique merged skills present with a combined amount present measure, that is, the merged amount measure, and a combined credibility measure, that is, the merged credibility measure. The merging module 201 further comprises a combining module 207 to combine multiple occurrences of the opportunity seeker skills in the first skill list, that is, the list of skills present into a single merged skill, that is, a unique opportunity seeker skill with a corresponding merged amount measure and a corresponding merged credibility measure. The combining module 207 further configured to assemble the single sub-list of skills present comprising the opportunity seeker skills with corresponding computed skill values into a list. The combining module 207 further comprises a compute skill values model 210 and a skill combiner 212. The compute skill values model 210 computes skill values, that is, a weighted skill amount measure and a weighted credibility measure for each opportunity seeker skill in the N sub-lists of skills present. The compute skill values module 210 further configured to return an opportunity seeker skill in the sub-list of skills present with the computed values of the weighted amount present measure and the weighted credibility measure. The skill combiner 212 returns a single merged or combined skill, that is, a unique opportunity seeker skill on combining the enhanced skills present tuples, that is, the tuples with the opportunity seeker skills and corresponding weighted skill amount measures and corresponding weighted credibility measures. The merging module 201 merges multiple reports or occurrences of an opportunity seeker skill, wherein the reports are of mixed credibility measures.

The matching module 202 matches the list of unique merged skills present and the second skill list and returns a list of matched skill entries. The matching module 202 further comprises a skill entry matching module 221 and a create matched skill module 226. The skill entry matching module 221 receives the list of matched skill entries and returning a list of matched skills. The skill entry matching module 221 further configured to examine whether the list of unique merged skills present contains the skills needed, that is, the opportunity description skill and passes the unique opportunity seeker skill that is the same as the opportunity description skill_present to the create matched skill module 226.

The create matched skill module 226 accepts the skill_present and the opportunity description skill and for creating a matched skill tuple comprising an opportunity description skill amount measure, an importance measure, and a requirement measure of the opportunity description skill and a merged skill amount measure and a merged credibility measure of the skill_present. The score generation module 203 generates an opportunity match score with the list of matched skills and returns a single numerical match score. The score generation module 203 further comprises a match score generation module 228 and a final match score generation module 231. The match score generation module 228 generates a scored matched skill based on each matched skill, additional values of a delta and a match score by determining the deviation in the merged skill amount measure and the opportunity description skill amount measure. The final score generation module 231 calculates a single numerical match score by determining the degree of match between the opportunity description skills and the opportunity seeker skills. The opportunity matching system 200 further comprise an operational system 1505 of a plurality of entities. The operational system 1505 of the opportunity matching system 200 estimates the credibility of the opportunity seeker skill amount measure corresponding to the opportunity seeker skills and assigns the credibility measure based on the estimated credibility to the opportunity seeker skill amount measure.

The opportunity matching system 200 stores the opportunity seeker skills in the opportunity seeker profiles and the opportunity description skills required for an opportunity in a skill list database 224 of the opportunity matching system 200. The skill list database 224 of the opportunity matching system 200 can be any storage area or medium that can be used for storing data and files. In an embodiment, the opportunity matching system 200 stores the received information in external databases, for example, a structured query language (SQL) data store or a not only SQL (NoSQL) data store such as the Microsoft® SQL Server®, the Oracle® servers, the MySQL® database of MySQL AB Company, the mongoDB® of MongoDB, Inc., the Neo4j graph database of Neo Technology Corporation, the Cassandra database of the Apache Software Foundation, the HBase™ database of the Apache Software Foundation, etc. In another embodiment, the skill list database 224 can be a location on a file system. In another embodiment, the skill list database 224 can be remotely accessed by the opportunity matching system 200 via the network 1501. In another embodiment, the skill list database 224 is configured as a cloud based database implemented in a cloud computing environment, where computing resources are delivered as a service over the network 1501.

Computer applications and programs are used for operating the modules of the opportunity matching system 200. The programs are loaded onto the fixed media drive 1512 and into the memory unit 1506 of the opportunity matching system 200 via the removable media drive 1513. In an embodiment, the computer applications and programs are loaded directly on the opportunity matching system 200 via the network 1501. The processor 1503 executes an operating system, for example, the Linux® operating system, the Unix® operating system, any version of the Microsoft® Windows® operating system, the Mac OS of Apple Inc., the IBM® OS/2, VxWorks® of Wind River Systems, Inc., QNX Neutrino® developed by QNX Software Systems Ltd., the Palm OS®, the Solaris operating system developed by Sun Microsystems, Inc., etc. The opportunity matching system 200 employs the operating system for performing multiple tasks. The operating system is responsible for management and coordination of activities and sharing of resources of the opportunity matching system 200. The operating system further manages security of the opportunity matching system 200, peripheral devices connected to the opportunity matching system 200, and network connections. The operating system employed on the opportunity matching system 200 recognizes, for example, inputs provided by a user of the opportunity matching system 200 using one of the input devices 1511, the output devices 1514, files, and directories stored locally on the fixed media drive 1512. The operating system on the opportunity matching system 200 executes different programs using the processor 1503. The processor 1503 and the operating system together define a computer platform for which application programs in high level programming languages are written.

The processor 1503 of the opportunity matching system 200 retrieves instructions defined by the receiving module 1507, the merging module 201, the matching module 202, the score generation module 203, the combining module 207, the compute skill values module 210, the skill combiner 212, the skill entry matching module 221, the create matched skill module 226, the match score generation module 228, and the final score generation module 231 for performing respective functions disclosed above. The processor 1503 retrieves instructions for executing the modules, for example, 1507, 201, 202, 203, 207, 210, 212, 221, 226, 228, 231, etc., of the opportunity matching system 200 from the memory unit 1506. A program counter determines the location of the instructions in the memory unit 1506. The program counter stores a number that identifies the current position in the program of each of the modules, for example, 1507, 201, 202, 203, 207, 210, 212, 221, 226, 228, 231 etc., of the opportunity matching system 200. The instructions fetched by the processor 1503 from the memory unit 1506 after being processed are decoded. The instructions are stored in an instruction register in the processor 1503. After processing and decoding, the processor 1503 executes the instructions, thereby performing one or more processes defined by those instructions.

At the time of execution, the instructions stored in the instruction register are examined to determine the operations to be performed. The processor 1503 then performs the specified operations. The operations comprise arithmetic operations and logic operations. The operating system performs multiple routines for performing a number of tasks required to assign the input devices 1511, the output devices 1514, and the memory unit 1506 for execution of the modules, for example, 1507, 201, 202, 203, 207, 210, 212, 221, 226, 228, 231, etc., of the opportunity matching system 200. The tasks performed by the operating system comprise, for example, assigning memory to the modules, for example, 1507, 201, 202, 203, 207, 210, 212, 221, 226, 228, 231, etc., of the opportunity matching system 200 and to data used by the opportunity matching system 200, moving data between the memory unit 1506 and disk units, and handling input/output operations. The operating system performs the tasks on request by the operations and after performing the tasks, the operating system transfers the execution control back to the processor 1503. The processor 1503 continues the execution to obtain one or more outputs. The outputs of the execution of the modules, for example, 1507, 201, 202, 203, 207, 210, 212, 221, 226, 228, 231, etc., of the opportunity matching system 200 are displayed to a user of the opportunity matching system 200 on the output device 1514. In an embodiment, one or more portions of the opportunity matching system 200 are distributed across one or more computer systems (not shown) coupled to the network 1501.

The non-transitory computer readable storage medium having embodied thereon, computer program codes comprising instructions executable by at least one processor 1503 for determining a degree of match between opportunity seeker profiles with opportunity seeker skills of varying credibility and opportunity descriptions with opportunity description skills of varying importance. The computer program codes comprise a first computer program code for receiving a first skill list comprising the opportunity seeker skills in the opportunity seeker profiles and a second skill list comprising the opportunity description skills required for an opportunity from a skill list database 224 by the opportunity matching system 200, wherein the first skill list comprises first tuples, each of the first tuples comprising one of the opportunity seeker skills, an opportunity seeker skill amount measure corresponding to the one of the opportunity seeker skills, and a credibility measure indicating credibility of the opportunity seeker skill amount measure, and wherein the second skill list comprises second tuples, each of the second tuples comprising one of the opportunity description skills, a requirement measure, an importance measure, and an opportunity description skill amount measure associated with the one of the opportunity description skills; a second program code for creating a unique skill list comprising unique opportunity seeker skills from the first skill list, a merged skill amount measure corresponding to each of the unique opportunity seeker skills, and a merged credibility measure indicating credibility of the merged skill amount measure by the opportunity matching system 200 by performing merging actions on the first tuples in the first skill list, wherein the merging actions comprise computing the merged skill amount measure and the merged credibility measure corresponding to the each of the unique opportunity seeker skills using the opportunity seeker skill amount measure and the credibility measure of each of the opportunity seeker skills of the first skill list; a third computer program code for creating a matched skill list by matching the unique opportunity seeker skills of the created unique skill list with the opportunity description skills of the second skill list by the opportunity matching system 200 on combining the created unique skill list with the second skill list; a fourth computer program code for generating a skill match score for each of the opportunity description skills in the created matched skill list on matching the unique opportunity seeker skills with the opportunity description skills by the opportunity matching system 200 using the requirement measure, the importance measure, the opportunity description skill amount measure, the merged skill amount measure, and the merged credibility measure; and a fifth computer program code for generating an opportunity match score defining the degree of match between the opportunity seeker profiles and the opportunity descriptions by the opportunity matching system 200 by processing the generated skill match score for the each of the opportunity description skills with the importance measure of the each of the opportunity description skills in the second skill list.

The non-transitory computer readable storage medium further comprise a sixth computer program code for determining whether an opportunity description skill is absent in the created unique skill list and assigning default values to the merged skill amount measure and the merged credibility measure corresponding to the opportunity description skill in the matched skill list by the opportunity matching system 200. The non-transitory computer readable storage medium, wherein fifth computer program code further comprise a seventh computer program code for determining deviations in the merged skill amount measure and the opportunity description skill amount measure by the opportunity matching system 200 using an amount measure deviation lookup table.

It will be readily apparent in different embodiments that the various methods, algorithms, and computer programs disclosed herein are implemented on non-transitory computer readable storage media appropriately programmed for computing devices. The non-transitory computer readable storage media participates in providing data, for example, instructions that are read by a computer, a processor or a similar device. In different embodiments, the “non-transitory computer readable storage media” further refers to a single medium or multiple media, for example, a centralized database, a distributed database, and/or associated caches and servers that store one or more sets of instructions that are read by a computer, a processor or a similar device. The “non-transitory computer readable storage media” further refers to any medium capable of storing or encoding a set of instructions for execution by a computer, a processor or a similar device and that causes a computer, a processor or a similar device to perform any one or more of the methods disclosed herein. Common forms of non-transitory computer readable storage media comprise, for example, a floppy disk, a flexible disk, a hard disk, magnetic tape, a laser disc, a Blu-ray Disc® of the Blu-ray Disc Association, any magnetic medium, a compact disc-read only memory (CD-ROM), a digital versatile disc (DVD), any optical medium, a flash memory card, punch cards, paper tape, any other physical medium with patterns of holes, a random access memory (RAM), a programmable read only memory (PROM), an erasable programmable read only memory (EPROM), an electrically erasable programmable read only memory (EEPROM), a flash memory, any other memory chip or cartridge, or any other medium from which a computer can read.

In an embodiment, the computer programs that implement the methods and algorithms disclosed herein are stored and transmitted using a variety of media, for example, the computer readable media in a number of manners. In an embodiment, hard-wired circuitry or custom hardware is used in place of, or in combination with, software instructions for implementing the processes of various embodiments. Therefore, the embodiments are not limited to any specific combination of hardware and software. The computer program codes comprising computer executable instructions can be implemented in any programming language. Examples of programming languages that can be used comprise C, C++, C#, Java®, JavaScript®, Fortran, Ruby, Perl®, Python®, Visual Basic®, hypertext preprocessor (PHP), Microsoft® .NET, Objective-C®, etc. Other object-oriented, functional, scripting, and/or logical programming languages can also be used. In an embodiment, the computer program codes or software programs are stored on or in one or more mediums as object code. In another embodiment, various aspects of the computer implemented method and the opportunity matching system 200 disclosed herein are implemented in a non-programmed environment comprising documents created, for example, in a hypertext markup language (HTML), an extensible markup language (XML), or other format that render aspects of a graphical user interface (GUI) or perform other functions, when viewed in a visual area or a window of a browser program. In another embodiment, various aspects of the computer implemented method and the opportunity matching system 200 disclosed herein are implemented as programmed elements, or non-programmed elements, or any suitable combination thereof.

Where databases are described such as the skill list database 224, it will be understood by one of ordinary skill in the art that (i) alternative database structures to those described may be employed, and (ii) other memory structures besides databases may be employed. Any illustrations or descriptions of any sample databases disclosed herein are illustrative arrangements for stored representations of information. In an embodiment, any number of other arrangements are employed besides those suggested by tables illustrated in the drawings or elsewhere. Similarly, any illustrated entries of the databases represent exemplary information only; one of ordinary skill in the art will understand that the number and content of the entries can be different from those disclosed herein. In another embodiment, despite any depiction of the databases as tables, other formats including relational databases, object-based models, and/or distributed databases are used to store and manipulate the data types disclosed herein. Object methods or behaviors of a database can be used to implement various processes such as those disclosed herein. In another embodiment, the databases are, in a known manner, stored locally or remotely from a device that accesses data in such a database. In embodiments where there are multiple databases in the opportunity matching system 200, the databases are integrated to communicate with each other for enabling simultaneous updates of data linked across the databases, when there are any updates to the data in one of the databases.

The computer implemented method and the opportunity matching system 200 disclosed herein can be configured to work in a network environment comprising one or more computers that are in communication with one or more devices via a network. In an embodiment, the computers communicate with the devices directly or indirectly, via a wired medium or a wireless medium such as the Internet, a local area network (LAN), a wide area network (WAN) or the Ethernet, a token ring, or via any appropriate communications mediums or combination of communications mediums. Each of the devices comprises processors, examples of which are disclosed above, that are adapted to communicate with the computers. In an embodiment, each of the computers is equipped with a network communication device, for example, a network interface card, a modem, or other network connection device suitable for connecting to a network. Each of the computers and the devices executes an operating system, examples of which are disclosed above. While the operating system may differ depending on the type of computer, the operating system provides the appropriate communications protocols to establish communication links with the network. Any number and type of machines may be in communication with the computers.

The computer implemented method and the opportunity matching system 200 disclosed herein are not limited to a particular computer system platform, processor, operating system, or network. In an embodiment, one or more aspects of the computer implemented method and the opportunity matching system 200 disclosed herein are distributed among one or more computer systems, for example, servers configured to provide one or more services to one or more client computers, or to perform a complete task in a distributed system. For example, one or more aspects of the computer implemented method and the opportunity matching system 200 disclosed herein are performed on a client-server system that comprises components distributed among one or more server systems that perform multiple functions according to various embodiments. These components comprise, for example, executable, intermediate, or interpreted code, which communicate over a network using a communication protocol. The computer implemented method and the opportunity matching system 200 disclosed herein are not limited to be executable on any particular system or group of systems, and are not limited to any particular distributed architecture, network, or communication protocol.

The foregoing examples have been provided merely for explanation and are in no way to be construed as limiting of the method and the opportunity matching system 200 disclosed herein. While the method and the opportunity matching system 200 have been described with reference to various embodiments, it is understood that the words, which have been used herein, are words of description and illustration, rather than words of limitation. Furthermore, although the method and the opportunity matching system 200 have been described herein with reference to particular means, materials, and embodiments, the method and the opportunity matching system 200 are not intended to be limited to the particulars disclosed herein; rather, the method and the opportunity matching system 200 extend to all functionally equivalent structures, methods and uses, such as are within the scope of the appended claims. While multiple embodiments are disclosed, it will be understood by those skilled in the art, having the benefit of the teachings of this specification, that the method and the opportunity matching system 200 disclosed herein are capable of modifications and other embodiments may be effected and changes may be made thereto, without departing from the scope and spirit of the method and the opportunity matching system 200 disclosed herein.

We claim:

1. A method for determining a degree of match between opportunity seeker profiles with opportunity seeker skills of varying credibility and opportunity descriptions with opportunity description skills of varying importance, said method employing an opportunity matching system comprising at least one processor configured to execute computer program instructions for performing said method comprising:
receiving a first skill list comprising said opportunity seeker skills in said opportunity seeker profiles and a second skill list comprising said opportunity description skills required for an opportunity from a skill list database by said opportunity matching system, wherein said first skill list comprises first tuples, each of said first tuples comprising one of said opportunity seeker skills, an opportunity seeker skill amount measure corresponding to said one of said opportunity seeker skills, and a credibility measure indicating credibility of said opportunity seeker skill amount measure, and wherein said second skill list comprises second tuples, each of said second tuples comprising one of said opportunity description skills, a requirement measure, an importance measure, and an opportunity description skill amount measure associated with said one of said opportunity description skills;
creating a unique skill list comprising unique opportunity seeker skills from said first skill list, a merged skill amount measure corresponding to each of said unique opportunity seeker skills, and a merged credibility measure indicating credibility of said merged skill amount measure by said opportunity matching system by performing merging actions on said first tuples in said first skill list, wherein said merging actions comprise computing said merged skill amount measure and said merged credibility measure corresponding to said each of said unique opportunity seeker skills using said opportunity seeker skill amount measure and said credibility measure of each of said opportunity seeker skills of said first skill list;
creating a matched skill list by matching said unique opportunity seeker skills of said created unique skill list with said opportunity description skills of said second skill list by said opportunity matching system on combining said created unique skill list with said second skill list;
generating a skill match score for each of said opportunity description skills in said created matched skill list on matching said unique opportunity seeker skills with said opportunity description skills by said opportunity matching system using said requirement measure, said importance measure, said opportunity description skill amount measure, said merged skill amount measure, and said merged credibility measure; and
generating an opportunity match score defining said degree of match between said opportunity seeker profiles and said opportunity descriptions by said opportunity matching system by processing said generated skill match score for said each of said opportunity description skills with said importance measure of said each of said opportunity description skills in said second skill list.

2. The method of claim 1, further comprising determining whether an opportunity description skill is absent in said created unique skill list and assigning default values to said merged skill amount measure and said merged credibility measure corresponding to said opportunity description skill in said matched skill list by said opportunity matching system.

3. The method of claim 1, wherein said opportunity seeker skill is one of a core personal trait and a domain of expertise of an opportunity seeker extracted from said opportunity seeker profiles.

4. The method of claim 1, wherein said generation of said skill match score for said each of said opportunity description skills in said created matched skill list comprises determining deviations in said merged skill amount measure and said opportunity description skill amount measure by said opportunity matching system using an amount measure deviation lookup table.

5. The method of claim 1, wherein the opportunity seeker skill amount measure is a fraction of a total skill amount measure of the opportunity seeker skills possessed by one or more opportunity seekers, and wherein the opportunity description skill amount measure is a quantized value of the proficiency of one or more opportunity seekers needed for the opportunity.

6. The method of claim 1, comprises:
estimating the credibility of the opportunity seeker skill amount measure corresponding to the opportunity seeker skills by an operational system of a plurality of entities; and
assigning the credibility measure based on the estimated credibility to the opportunity seeker skill amount measure by the operational system of the plurality of entities.

7. The method of claim 1, wherein the requirement measure is a Boolean value associated with an opportunity description skill representing that the opportunity seeker skill amount measure of the opportunity seeker skill is required to be equal to the opportunity description skill amount measure of the opportunity description skill, wherein the opportunity description skill is the same as the opportunity seeker skill, and wherein the importance measure is a quantized value representing a degree to which presence of an opportunity description skill in the first skill list is needed for an opportunity.

8. The method of claim 1, wherein the unique opportunity seeker skills is a list of opportunity seeker skills with multiple occurrences in the first skill list that are merged to a single occurrence.

9. The method of claim 1, wherein the merged skill amount measure is a combined value of the opportunity seeker skill amount measures corresponding to the multiple occurrences of the opportunity seeker skills in the first skill list, and wherein the merged credibility measure is a combined value of the credibility measures corresponding to the multiple occurrences of the opportunity seeker skills in the first skill list.

10. The method of claim 9, wherein the credibility bump is added to an unadjusted credibility measure to generate a merged credibility measure of the opportunity seeker skill based on the number of reports and the credibility of the corresponding reports.

11. The method of claim 1 further comprises merging multiple reports or occurrences of an opportunity seeker skill by the opportunity matching system, wherein the reports are of mixed credibility measures.

12. A method for generating an opportunity match score implemented by the opportunity matching system on comparison of the opportunity seeker skills of varying credibility with the opportunity description skills of varying importance, the method comprising:
performing merging actions on the opportunity seeker skills in the first skill list and returning a list of unique merged skills present by a merging module of the opportunity matching system;
matching the list of unique merged skills present and the second skill list and returning a list of matched skill entries by a matching module of the opportunity matching system; and
generating an opportunity match score with the list of matched skills and returning a single numerical match score by a score generation module of the opportunity matching system.

13. The method of claim 12, further comprising receiving the list of matched skill entries by a skill entry matching module of the matching module and the returning a list of matched skills by the skill entry matching module.

14. An opportunity matching system for determining a degree of match between opportunity seeker profiles with opportunity seeker skills of varying credibility and opportunity descriptions with opportunity description skills of varying importance, the system comprising:
a non-transitory computer readable storage medium configured to store computer program instructions defined by modules of the opportunity matching system; and
at least one processor communicatively coupled to the non-transitory computer readable storage media, the at least one processor configured to execute the computer program instructions defined by modules of the opportunity matching system, the modules comprising:
a receiving module for receiving a first skill list comprising the opportunity seeker skills in the opportunity seeker profiles and a second skill list comprising the opportunity description skills required for an opportunity from a skill list database;
a merging module for performing merging actions on the opportunity seeker skills in the first skill list and returning a list of unique merged skills present;
a matching module for matching the list of unique merged skills present and the second skill list and returning a list of matched skill entries; and
a score generation module for generating an opportunity match score with the list of matched skills and returning a single numerical match score.

15. The opportunity matching system of claim 14, wherein the merging module is further configured to combine multiple occurrences of the opportunity seeker skills in the list of skills present into one entry per opportunity seeker skill in the list of unique merged skills present with a combined amount present measure, that is, the merged amount measure, and a combined credibility measure, that is, the merged credibility measure.

16. The opportunity matching system of claim 14, wherein the merging module further comprises a combining module for combining multiple occurrences of the opportunity seeker skills in the first skill list, that is, the list of skills present into a single merged skill, that is, a unique opportunity seeker skill with a corresponding merged amount measure and a corresponding merged credibility measure, wherein the combining module further comprises:
a compute skill values model for computing skill values, that is, a weighted skill amount measure and a weighted credibility measure for each opportunity seeker skill in the N sub-lists of skills present; and
a skill combiner for returning a single merged or combined skill, that is, a unique opportunity seeker skill on combining the enhanced skills present tuples, that is, the tuples with the opportunity seeker skills and corresponding weighted skill amount measures and corresponding weighted credibility measures.

17. The opportunity matching system of claim 14, wherein the merging module merges multiple reports or occurrences of an opportunity seeker skill, wherein the reports are of mixed credibility measures.

18. The opportunity matching system of claim 14, wherein the matching module further comprises:
a skill entry matching module for receiving the list of matched skill entries and returning a list of matched skills; and
a create matched skill module for accepting the skill_present and the opportunity description skill and for creating a matched skill tuple comprising an opportunity description skill amount measure, an importance measure, and a requirement measure of the opportunity description skill and a merged skill amount measure and a merged credibility measure of the skill_present.

19. The opportunity matching system of claim 14, wherein the scoring module further comprises:
a match score generation module for generating a scored matched skill based on each matched skill, additional values of a delta and a match score by determining the deviation in the merged skill amount measure and the opportunity description skill amount measure; and
a final score generation module for calculating a single numerical match score by determining the degree of match between the opportunity description skills and the opportunity seeker skills.

20. The opportunity matching system of claim 16, wherein the combining module is further configured for assembling the single sub-list of skills present comprising the opportunity seeker skills with corresponding computed skill values into a list.

21. The opportunity matching system of claim 16, wherein the compute skill values module is further configured for returning an opportunity seeker skill in the sub-list of skills present with the computed values of the weighted amount present measure and the weighted credibility measure.

22. The opportunity matching system of claim 18, wherein the skill entry matching module is further configured for examining whether the list of unique merged skills present contains the skills needed, that is, the opportunity description skill and passes the unique opportunity seeker skill that is the same as the opportunity description skill_present to the create matched skill module.

23. The opportunity matching system of claim 16, comprises an operational system of a plurality of entities, wherein the operational system comprises:
estimating the credibility of the opportunity seeker skill amount measure corresponding to the opportunity seeker skills; and
assigning the credibility measure based on the estimated credibility to the opportunity seeker skill amount measure.

24. A non-transitory computer readable storage medium having embodied thereon, computer program codes comprising instructions executable by at least one processor for determining a degree of match between opportunity seeker profiles with opportunity seeker skills of varying credibility and opportunity descriptions with opportunity description skills of varying importance, the computer program codes comprising:
a first computer program code for receiving a first skill list comprising the opportunity seeker skills in the opportunity seeker profiles and a second skill list comprising the opportunity description skills required for an opportunity from a skill list database by the opportunity matching system, wherein the first skill list comprises first tuples, each of the first tuples comprising one of the opportunity seeker skills, an opportunity seeker skill amount measure corresponding to the one of the opportunity seeker skills, and a credibility measure indicating credibility of the opportunity seeker skill amount measure, and wherein the second skill list comprises second tuples, each of the second tuples comprising one of the opportunity description skills, a requirement measure, an importance measure, and an opportunity description skill amount measure associated with the one of the opportunity description skills;
a second program code for creating a unique skill list comprising unique opportunity seeker skills from the first skill list, a merged skill amount measure corresponding to each of the unique opportunity seeker skills, and a merged credibility measure indicating credibility of the merged skill amount measure by the opportunity matching system by performing merging actions on the first tuples in the first skill list, wherein the merging actions comprise computing the merged skill amount measure and the merged credibility measure corresponding to the each of the unique opportunity seeker skills using the opportunity seeker skill amount measure and the credibility measure of each of the opportunity seeker skills of the first skill list;
a third computer program code for creating a matched skill list by matching the unique opportunity seeker skills of the created unique skill list with the opportunity description skills of the second skill list by the opportunity matching system on combining the created unique skill list with the second skill list;
a fourth computer program code for generating a skill match score for each of the opportunity description skills in the created matched skill list on matching the unique opportunity seeker skills with the opportunity description skills by the opportunity matching system using the requirement measure, the importance measure, the opportunity description skill amount measure, the merged skill amount measure, and the merged credibility measure; and
a fifth computer program code for generating an opportunity match score defining the degree of match between the opportunity seeker profiles and the opportunity descriptions by the opportunity matching system by processing the generated skill match score for the each of the opportunity description skills with the importance measure of the each of the opportunity description skills in the second skill list.

25. The non-transitory computer readable storage medium of claim 24, further comprising a sixth computer program code for determining whether an opportunity description skill is absent in the created unique skill list and assigning default values to the merged skill amount measure and the merged credibility measure corresponding to the opportunity description skill in the matched skill list by the opportunity matching system.

26. The non-transitory computer readable storage medium of claim 24, wherein fifth computer program code further comprises a seventh computer program code for determining deviations in the merged skill amount measure and the opportunity description skill amount measure by the opportunity matching system using an amount measure deviation lookup table.
